(19) United States
(12) Patent Application Publication
(10) Pub. No.: US 2025/0070928 A1
(43) Pub. Date: Feb. 27, 2025

(54) ENCODING METHOD AND APPARATUS

(71) Applicant: HUAWEI TECHNOLOGIES CO., LTD., Shenzhen (CN)

(72) Inventors: Dao Pan, Dongguan (CN); Huawei Yue, Shanghai (CN); Yongli Yan, Shenzhen (CN); Zefeng Lin, Dongguan (CN); Xiaoming Jiang, Dongguan (CN)

(21) Appl. No.: 18/942,216

(22) Filed: Nov. 8, 2024

Related U.S. Application Data
(63) Continuation of application No. PCT/CN2023/089929, filed on Apr. 21, 2023.

(30) Foreign Application Priority Data
May 11, 2022 (CN) 202210515741.8

(51) Int. Cl. H04L 5/00; H04L 25/03; H04L 27/26

(52) U.S. Cl. CPC H04L 5/0007; H04L 25/03929; H04L 27/2678

(57) ABSTRACT

Embodiments of this application provide an encoding method and apparatus, to improve an encoding gain in an RCM. The method includes: performing bit mapping on kᵣᵥ₁ information source bits whose reliability is lower than a first threshold in a first bit sequence, to obtain a second bit sequence, where the first bit sequence is a bit sequence obtained by performing bit mapping after cyclic redundancy check CRC bits are added to an information source bit sequence, the kᵣᵥ₁ information source bits are bits in the information source bit sequence, and a length of the first bit sequence is equal to a length of the second bit sequence; performing an exclusive OR operation on bits in a bit sequence obtained by encoding the first bit sequence and bits in a bit sequence obtained by encoding the second bit sequence, to obtain a third bit sequence; or encoding the second bit sequence, to obtain a third bit sequence; and mapping, to an orthogonal frequency-division multiplexing OFDM symbol, the third bit sequence and the bit sequence obtained by encoding the first bit sequence.

### CROSS-REFERENCE TO RELATED APPLICATIONS

This application is a continuation of International Application No. PCT/CN2023/089929, filed on Apr. 21, 2023, which claims priority to Chinese Patent Application No. 202210515741.8, filed on May 11, 2022. The disclosures of the aforementioned applications are hereby incorporated by reference in their entireties.

### TECHNICAL FIELD

This application relates to the field of communication technologies, and in particular, to an encoding method and apparatus.

### BACKGROUND

In a smart home scenario, to implement large-scale interconnection of smart household devices, an existing power network may be used. However, irregular and high-intensity pulse interference may be generated between power-consuming devices on a power cable. Therefore, a robust communication mode (robust communication mode, RCM) is used in the international telecommunications union-telecommunications standardization sector (international telecommunications union-telecommunications standardization sector, ITU-T) G.9960 protocol to resist the pulse interference, thereby improving reliability of information transmission.

Specifically, in the RCM, as shown in FIG. 1, S sections (sessions), whose index numbers are sequentially 0, 1, 2, . . . , and S-1, of a codeword (codeword) that has undergone polarization encoding and rate matching form a first group of S sections (group #1 of S sessions). The S sections in the first group of S sections are cyclically shifted based on a parameter CSS₂, to obtain S sections whose index numbers are sequentially CSS₂ (CSS₂+1)%S (CSS₂+2)%S, and (CSS₂+S−1)%S, that is, a second group of S sections (group #2 of S sessions). The second group of S sections and the first group of S sections are concatenated. Similarly, the S sections in the first group of S sections may be alternatively cyclically shifted separately based on parameters CSS₃, . . . , and CSS_{N}_{ᵣₑₚ}−1, and then sequentially concatenated. Finally, the S sections in the first group of S sections are cyclically shifted based on a parameter CSS_{N}_{ᵣₑₚ}, to obtain S sections whose index numbers are sequentially CSS_{N}_{ᵣₑₚ}, (CSS_{N}_{ᵣₑₚ}+1)%S (CSS_{N}_{ᵣₑₚ}+2)%S and (CSS_{N}_{ᵣₑₚ}+S−1)%S, that is, a CSS_{N}_{ᵣₑₚ}ₜₕ group of S sections (group #CSS_{N}_{ᵣₑₚ} of S sessions). The and a previous obtained CSS_{N}_{ᵣₑₚ}−1ₜₕ group of S sections are concatenated. Values of the parameters CSS₂, CSS₃, . . . , CSS_{N}_{ᵣₑₚ} and may be obtained by querying a table. The first group of S sections may also be referred to as a first forward error correction (forward error correction, FEC) codeword copy (FEC copy 190 1), the second group of S sections may also be referred to as a second FEC copy, . . . , and the CSS_{N}_{ᵣₑₚ}ₜₕ group of S sections may also be referred to as a CSS_{N}_{ᵣₑₚ}ₜₕ FEC copy.

In the foregoing RCM, the S sections of the codeword that has undergone rate matching are repeated for Nᵣₑₚ times, and are cyclically shifted in each repetition based on a corresponding cyclic section shift (cyclic section shift, CSS) parameter, to resist pulse interference that may be received in a transmission process. However, with an increase of rep, Nᵣₑₚ, a chase combine (chase combine, CC) gain that a receive end can obtain is limited.

### SUMMARY

Embodiments of this application provide an encoding method and apparatus, to improve an encoding gain in an RCM. To achieve the foregoing objectives, the following technical solutions are used in embodiments of this application.

According to a first aspect, an encoding method is provided. An apparatus for performing the encoding method may be an encoding apparatus, or may be a module used in an encoding apparatus, for example, a Bluetooth chip or a chip system. The method includes: performing bit mapping on kᵣᵥ₁ information source bits whose reliability is lower than a first threshold in a first bit sequence, to obtain a second bit sequence, where the first bit sequence is a bit sequence obtained by performing bit mapping after cyclic redundancy check CRC bits are added to an information source bit sequence, the kᵣᵥ₁ information source bits are bits in the information source bit sequence, and a length of the first bit sequence is equal to a length of the second bit sequence; performing an exclusive OR operation on bits in a bit sequence obtained by encoding the first bit sequence and bits in a bit sequence obtained by encoding the second bit sequence, to obtain a third bit sequence; or encoding the second bit sequence, to obtain a third bit sequence; and mapping, to an orthogonal frequency-division multiplexing OFDM symbol, the third bit sequence and the bit sequence obtained by encoding the first bit sequence.

For a same information source bit sequence, the second bit sequence is introduced in the encoding method provided in this embodiment of this application, so that the third bit sequence and the bit sequence obtained by encoding the first bit sequence can be mapped to the OFDM symbol. This is different from a prior-art solution of directly encoding the first bit sequence and performing mapping to the OFDM symbol. Apparently, in this embodiment of this application, for the same information source bit sequence, the bit sequence obtained by encoding the first bit sequence is obtained, and more encoded codewords, that is, the third bit sequence, may be obtained. If a signal is affected by pulse interference in a transmission process, a proportion of an erroneous codeword in all codewords is smaller than that in the conventional technologies. In other words, in this embodiment of this application, more redundant information is introduced, so that a receive-end apparatus can correctly recover source data at a higher probability, thereby improving an encoding gain and improving reliability of an entire system. In addition, in this embodiment of this application, the kᵣᵥ₁ information source bits whose reliability is lower than the first threshold may be selected from the first bit sequence to generate the second bit sequence. Because a bit with low reliability is more likely to encounter an error when the receive-end apparatus performs decoding, the second bit sequence is generated by using the kᵣᵥ₁ information source bits, and the second bit sequence is further encoded to obtain the third bit sequence. In this way, decoding performance of the receive-end apparatus can be enhanced.

With reference to the first aspect, in a possible implementation, the mapping, to an OFDM symbol, the third bit sequence and the bit sequence obtained by encoding the first bit sequence includes: performing rate matching on the bit sequence obtained by encoding the first bit sequence, then performing segmentation to obtain M₁ groups of S sections, and performing the following operations on an x₁^{th} group of S sections: repeating the x₁^{th} group of S sections for Nᵣᵥ₀ times, and performing cyclic shift based on a corresponding cyclic section shift CSS parameter in each repetition, to obtain Nᵣᵥ₀×S sections, where M₁, S, x₁, and Nᵣᵥ₀ are all positive integers, and 1≤x₁≤M₁; performing rate matching on the third bit sequence, then performing segmentation to obtain M₁ groups of S sections, and performing the following operations on an x₂^{th} group of S sections: repeating the x₂^{th} group of S sections for Nᵣᵥ₁ times, and performing cyclic shift based on a corresponding CSS parameter in each repetition, to obtain Nᵣᵥ₁×S sections, where x₂ and Nᵣᵥ₁ are both positive integers, and 1≤x₂≤M₁; and sequentially concatenating the Nᵣᵥ₀×S sections and the Nᵣᵥ₁×S sections, and performing mapping to the OFDM symbol; or concatenating the Nᵣᵥ₀×S sections and the Nᵣᵥ₁×S sections in an interleaving manner in a unit of a section, and performing mapping to the OFDM symbol. In this solution, segmentation, repetition, cyclic shift, and combination are appropriately performed on the third bit sequence and the bit sequence obtained by encoding the first bit sequence, and then mapping is performed to the OFDM symbol, so that more encoded codewords are carried on the same OFDM symbol.

With reference to the first aspect, in a possible implementation, Kᵣᵥ₁ bits whose reliability is higher than a second threshold in the second bit sequence are obtained by adding Lᵣᵥ₁ CRC bits to kᵣᵥ₁ information source bits whose reliability is lower than the first threshold in the first bit sequence, where Kᵣᵥ₁=kᵣᵥ₁+Lᵣᵥ₁, kᵣᵥ₁, Lᵣᵥ₁, and Kᵣᵥ₁ are positive integers. In this solution, the Lᵣᵥ₁ CRC bits are added to the kᵣᵥ₁ information source bits whose reliability is lower than the first threshold in the first bit sequence, to check whether an error occurs in a transmission process of the kᵣᵥ₁ information source bits, thereby improving accuracy of recovering source data by the receive-end apparatus.

With reference to the first aspect, in a possible implementation, the performing rate matching on the bit sequence obtained by encoding the first bit sequence, and then performing segmentation to obtain M₁ groups of S sections includes: performing division to obtain M codewords, after rate matching is performed on the bit sequence obtained by encoding the first bit sequence, where each codeword includes E bits; repeating a final codeword in the M codewords for a plurality of times, so that a quantity of codewords is H×M₂; dividing the H×M₂ codewords into M₂ groups, where each group includes H codewords; and performing the following operations on an x₃^{th} group of H codewords: concatenating the H codewords, and placing concatenated H×E bits into a first cyclic buffer; and concatenating first B×S−H×E bits in the H codewords at an end of the H codewords, where H, E, M₂, and x₃ are all positive integers, 1≤x₃≤M₂, and B represents a quantity of bits in each section; and reading B×S bits from the cyclic buffer, to generate one group of S sections, where each section includes B bits. For a segmentation process in this solution, refer to related steps in the conventional technologies. Therefore, compatibility between this solution and the conventional technologies can be improved.

With reference to the first aspect, in a possible implementation, the performing rate matching on the third bit sequence, and then performing segmentation to obtain M₁ groups of S sections includes: performing division to obtain M codewords, after rate matching is performed on the third bit sequence, where each codeword includes E bits; repeating a final codeword in the M codewords for a plurality of times, so that a quantity of codewords is H×M₂; dividing the H×M₂ codewords into M₂ groups, where each group includes H codewords; and performing the following operations on an x₃^{th} group of H codewords: concatenating the H codewords, and placing concatenated H×E bits into a first cyclic buffer; and concatenating first B×S−H×E bits in the H codewords at an end of the H codewords, where H, E, M₂, and x₃ are all positive integers, 1≤x₃≤M₂, and B represents a quantity of bits in each section; and reading B×S bits from the cyclic buffer, to generate one group of S sections, where each section includes B bits. For a segmentation process in this solution, refer to related steps in the conventional technologies. Therefore, compatibility between this solution and the conventional technologies can be improved.

With reference to the first aspect, in a possible implementation, the performing rate matching on the bit sequence obtained by encoding the first bit sequence includes: performing bit interleaving on a fourth bit sequence, where the fourth bit sequence is a bit sequence obtained by performing sub-block interleaving and bit selection on the bit sequence obtained by encoding the first bit sequence; and the performing rate matching on the third bit sequence includes: performing bit interleaving on a fifth bit sequence, where the fifth bit sequence is a bit sequence obtained by performing sub-block interleaving and bit selection on the third bit sequence.

With reference to the first aspect, in a possible implementation, the encoding method provided in this embodiment of this application further includes: placing a fourth bit sequence and a fifth bit sequence into a second cyclic buffer, where the fourth bit sequence is a bit sequence obtained by performing sub-block interleaving and bit selection on the bit sequence obtained by encoding the first bit sequence, and the fifth bit sequence is a bit sequence obtained by performing sub-block interleaving and bit selection on the third bit sequence; and when the information source bit sequence is retransmitted, reading the bit sequence from an initial bit of the fourth bit sequence or the fifth bit sequence, and performing bit interleaving on the read bit sequence. In this solution, when the information source bit sequence is retransmitted, only a sequence in the second cyclic buffer needs to be read and then interleaved. In this case, steps of CRC addition, bit mapping, encoding, sub-block interleaving, and/or bit selection do not need to be performed again, to save software and hardware resources and time.

According to a second aspect, an encoding apparatus is provided, to implement the foregoing method. The encoding apparatus includes corresponding modules, units, or means (means) for implementing the foregoing method. The modules, units, or means may be implemented by hardware, software, or hardware executing corresponding software. The hardware or the software includes one or more modules or units corresponding to the foregoing functions.

With reference to the second aspect, in a possible implementation, the encoding apparatus includes a processor and a memory coupled to the processor. The memory is configured to store a program and data. The processor is configured to execute the program stored in the memory, to implement the following functions: the processor is configured to perform bit mapping on kᵣᵥ₁ information source bits whose reliability is lower than a first threshold in a first bit sequence, to obtain a second bit sequence, where the first bit sequence is a bit sequence obtained by performing bit mapping after cyclic redundancy check CRC bits are added to an information source bit sequence, the kᵣᵥ₁ information source bits are bits in the information source bit sequence, and a length of the first bit sequence is equal to a length of the second bit sequence; the processor is further configured to perform an exclusive OR operation on bits in a bit sequence obtained by encoding the first bit sequence and bits in a bit sequence obtained by encoding the second bit sequence, to obtain a third bit sequence; or the processor is further configured to encode the second bit sequence, to obtain a third bit sequence; and the processor is further configured to map, to an orthogonal frequency-division multiplexing OFDM symbol, the third bit sequence and the bit sequence obtained by encoding the first bit sequence.

With reference to the second aspect, in a possible implementation, that the processor is further configured to map, to an OFDM symbol, the third bit sequence and the bit sequence obtained by encoding the first bit sequence includes that the processor is configured to: perform rate matching on the bit sequence obtained by encoding the first bit sequence, then perform segmentation to obtain M₁ groups of S sections, and perform the following operations on an x₁^{th} group of S sections: repeating the x₁^{th} group of S sections for Nᵣᵥ₀ times, and performing cyclic shift based on a corresponding cyclic section shift CSS parameter in each repetition, to obtain Nᵣᵥ₀×S sections, where M₁, S, x₁, and Nᵣᵥ₀ are all positive integers, and 1≤x₁≤M₁; the processor is configured to: perform rate matching on the third bit sequence, then perform segmentation to obtain M₁ groups of S sections, and perform the following operations on an x₂^{th} group of S sections: repeating the x₂^{th} group of S sections for Nᵣᵥ₁ times, and performing cyclic shift based on a corresponding CSS parameter in each repetition, to obtain Nᵣᵥ₁×S sections, where x₂ and Nᵣᵥ₁ are both positive integers, and 1≤x₂≤M₁; and the processor is configured to: sequentially concatenate the Nᵣᵥ₀×S sections and the Nᵣᵥ₁×S sections, and perform mapping to the OFDM symbol; or concatenate the Nᵣᵥ₀×S sections and the Nᵣᵥ₁×S sections in an interleaving manner in a unit of a section, and perform mapping to the OFDM symbol.

With reference to the second aspect, in a possible implementation, Kᵣᵥ₁ bits whose reliability is higher than a second threshold in the second bit sequence are obtained by adding Lᵣᵥ₁ CRC bits to kᵣᵥ₁ information source bits whose reliability is lower than the first threshold in the first bit sequence, where Kᵣᵥ₁=kᵣᵥ₁+Lᵣᵥ₁, kᵣᵥ₁, Lᵣᵥ₁, and Kᵣᵥ₁ are positive integers.

With reference to the second aspect, in a possible implementation, the communication apparatus further includes a memory. That the processor is further configured to: perform rate matching on the bit sequence obtained by encoding the first bit sequence, and then perform segmentation to obtain M₁ groups of S sections includes that the processor is configured to: perform division to obtain M codewords, after rate matching is performed on the bit sequence obtained by encoding the first bit sequence, where each codeword includes E bits; repeat a final codeword in the M codewords for a plurality of times, so that a quantity of codewords is H×M₂; and divide the H×M₂ codewords into M₂ groups, where each group includes H codewords; and the processor is configured to perform the following operations on an x₃^{th} group of H codewords: concatenating the H codewords, and placing concatenated H×E bits into the memory; and concatenating first B×S−H×E bits in the H codewords at an end of the H codewords, where H, E, M₂, and x₃ are all positive integers, 1≤x₃≤M₂, and B represents a quantity of bits in each section; and reading B×S bits from the memory, to generate one group of S sections, where each section includes B bits.

With reference to the second aspect, in a possible implementation, the communication apparatus further includes a memory. That the processor is further configured to: perform rate matching on the third bit sequence, and then perform segmentation to obtain M₁ groups of S sections includes that the processor is configured to: perform division to obtain M codewords, after rate matching is performed on the third bit sequence, where each codeword includes E bits; repeat a final codeword in the M codewords for a plurality of times, so that a quantity of codewords is H×M₂; and divide the H×M₂ codewords into M₂ groups, where each group includes H codewords; and the processor is configured to perform the following operations on an x₃^{th} group of H codewords: concatenating the H codewords, and placing concatenated H×E bits into the memory; and concatenating first B×S−H×E bits in the H codewords at an end of the H codewords, where H, E, M₂, and x₃ are all positive integers, 1≤x₃≤M₂, and B represents a quantity of bits in each section; and the processor is configured to read B×S bits from the memory, to generate one group of S sections, where each section includes B bits.

With reference to the second aspect, in a possible implementation, that the processor is further configured to perform rate matching on the bit sequence obtained by encoding the first bit sequence includes that the processor is configured to perform bit interleaving on a fourth bit sequence, where the fourth bit sequence is a bit sequence obtained by performing sub-block interleaving and bit selection on the bit sequence obtained by encoding the first bit sequence; and that the processor is further configured to perform rate matching on the third bit sequence includes that the processor is configured to perform bit interleaving on a fifth bit sequence, where the fifth bit sequence is a bit sequence obtained by performing sub-block interleaving and bit selection on the third bit sequence.

With reference to the second aspect, in a possible implementation, the communication apparatus further includes a memory. The processor is further configured to place a fourth bit sequence and a fifth bit sequence into the memory. The fourth bit sequence is a bit sequence obtained by performing sub-block interleaving and bit selection on the bit sequence obtained by encoding the first bit sequence. The fifth bit sequence is a bit sequence obtained by performing sub-block interleaving and bit selection on the third bit sequence. The processor is further configured to: when the information source bit sequence is retransmitted, read the bit sequence from an initial bit of the fourth bit sequence or the fifth bit sequence, and perform bit interleaving on the read bit sequence.

According to a third aspect, a communication apparatus is provided, including a processor. The processor is configured to: couple to a memory, read computer instructions stored in the memory, and perform the method in the first aspect according to the instructions.

With reference to the third aspect, in a possible implementation, the communication apparatus further includes the memory. The memory is configured to store the computer instructions.

With reference to the third aspect, in a possible implementation, the communication apparatus further includes a communication interface. The communication interface is used by the communication apparatus to communicate with another device. For example, the communication interface may be a transceiver, an input/output interface, an interface circuit, an output circuit, an input circuit, a pin, or a related circuit.

With reference to the third aspect, in a possible implementation, the communication apparatus may be a chip or a chip system. When the communication apparatus is the chip system, the communication apparatus may include a chip, or may include a chip and another discrete device.

According to a fourth aspect, a computer-readable storage medium is provided. The computer-readable storage medium stores instructions. When the instructions are run on a computer, the computer is enabled to perform the method in the first aspect.

According to a fifth aspect, a transmit-end apparatus is provided. The transmit-end apparatus includes a front-end module and the encoding apparatus in the second aspect. The encoding apparatus is configured to: encode an information source bit sequence, and perform mapping to an OFDM symbol. The front-end module is configured to: convert an output of the encoding apparatus into a wireless signal, and send the wireless signal.

With reference to the fifth aspect, in a possible implementation, the transmit-end apparatus further includes a modulation module. That the front-end module is configured to: convert an output of the encoding apparatus into a wireless signal, and send the wireless signal includes that the front-end module is configured to modulate, by using the modulation module, the output of the encoding apparatus into a high-frequency signal; and the front-end module is configured to: convert the high-frequency signal into a wireless signal, and send the wireless signal.

According to a sixth aspect, a communication system is provided. The communication system includes a receive-end apparatus and the transmit-end apparatus in the fifth aspect. The receive-end apparatus is configured to: receive a wireless signal from the transmit-end apparatus, and recover an information source bit sequence based on the wireless signal.

According to a seventh aspect, a computer program product including instructions is provided. When the computer program product runs on a computer, the computer is enabled to perform the method in the first aspect.

For technical effects brought by any one of possible implementations of the second aspect to the seventh aspect, refer to the technical effects brought by the first aspect or the different implementations of the first aspect. Details are not described herein again.

### BRIEF DESCRIPTION OF DRAWINGS

FIG. 1 is a diagram 1 of a principle of an existing RCM solution;

FIG. 2 is a flowchart of parameter calculation in an existing RCM solution;

FIG. 3 is a diagram 2 of a principle of an existing RCM solution;

FIG. 4 is a diagram 1 of an architecture of a communication system according to an embodiment of this application;

FIG. 5 is a diagram 2 of an architecture of a communication system according to an embodiment of this application;

FIG. 6 is a diagram 1 of a structure of a communication apparatus according to an embodiment of this application;

FIG. 7 is a flowchart of an encoding method according to an embodiment of this application;

FIG. 8 is a diagram of adding CRC bits to an information source bit sequence by an encoding apparatus according to an embodiment of this application;

FIG. 9 is a diagram of a manner of generating a first bit sequence according to an embodiment of this application;

FIG. 10 is a diagram of a manner of generating a second bit sequence according to an embodiment of this application;

FIG. 11 is a diagram of performing polar code encoding on a first bit sequence by an encoding apparatus according to an embodiment of this application;

FIG. 12 is a diagram of a manner of generating a third bit sequence according to an embodiment of this application;

FIG. 13 is a diagram of another manner of generating a third bit sequence according to an embodiment of this application;

FIG. 14 is a diagram of a manner of generating and processing a first bit sequence according to an embodiment of this application;

FIG. 15 is a diagram of bit selection according to an embodiment of this application;

FIG. 16 is a diagram of performing repetition and cyclic shift on S sections by an encoding apparatus according to an embodiment of this application;

FIG. 17 is a diagram of a relationship between a bit sequence and a start location according to an embodiment of this application; and

FIG. 18 is a diagram 2 of a structure of a communication apparatus according to an embodiment of this application.

### DESCRIPTION OF EMBODIMENTS

For ease of understanding of the technical solutions in embodiments of this application, the following first briefly describes technologies or terms related to this application.

### 1. Parameter Calculation in an RCM Solution

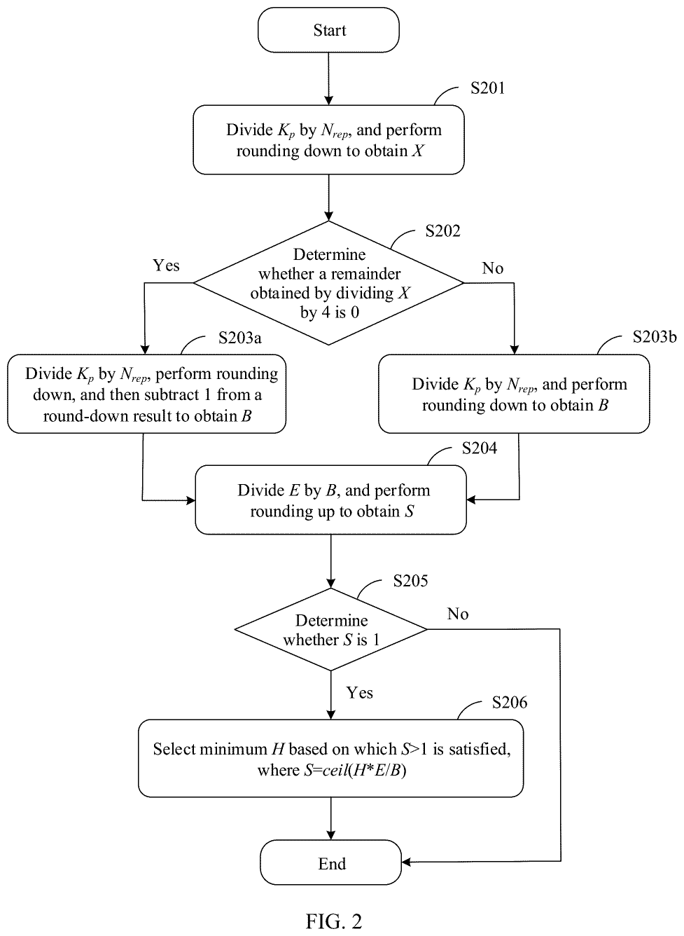

As described in the background, large-scale interconnection of smart household devices may be implemented by using an existing power network. Therefore, a power-line communication (power-line communication, PLC) technology emerges. In an orthogonal frequency-division multiplexing (orthogonal frequency-division multiplexing, OFDM)—based PLC system, based on given parameters including a quantity of bits that can be carried in each OFDM symbol: Kₚ, a quantity of repetitions of a codeword: Nᵣₑₚ, a quantity of bits included in each codeword: E, and a CSS, the parameters in the RCM solution that include a codeword concatenation coefficient H, a quantity of bits included in each section: B, and a quantity of sections included in each group: S′ may be calculated by using the following steps shown in FIG. 2:
Step S201: Divide Kₚ by Nᵣₑₚ, and perform rounding down to obtain X. This step may also be expressed in a programming language as: X=floor (Kₚ/Nᵣₑₚ).
Step S202: Determine whether a remainder obtained by dividing X by 4 is 0. This step may also be expressed in the programming language as: mod(X,4)=0. If a result of determining is yes, the following step S3a is performed; or if a result of determining is no, the following step S3b is performed.
Step S203a: Divide Kₚ by Nᵣₑₚ perform rounding down, and then subtract 1 from a round-down result to obtain B. This step may also be expressed in the programming language as: B=floor(Kₚ/Nᵣₑₚ)−1.
Step S203b: Divide Kₚ by Nᵣₑₚ, and perform rounding down to obtain B. This step may also be expressed in the programming language as: B−floor(Kₚ/Nᵣₑₚ).
Step S204: Divide E by B, and perform rounding up to obtain S. This step may also be expressed in the programming language as: S=ceil(E/B)
Step S205: Determine whether S is 1. If a result of determining is yes, the following step S6 is performed; or if a result of determining no, the procedure ends.
Step S206: Select minimum H based on which S>1 is satisfied, where S=ceil(H*E/B) For example, an initial value of H is 1, and may be substituted into the formula S=ceil(H*E/B) to obtain a value of S corresponding to H=1. If S>1 is not satisfied, the value of H is increased by 1, and becomes 2. The value of H is increased by 1 in each time until S>1 is satisfied. In this case, the value of H is not increased, and the value of H is the selected value.

It should be noted that H is a positive integer, and a default value is 1.

### 2. RCM Solution for Mapping, to an OFDM Symbol, a Codeword That Has Undergone Rate Matching

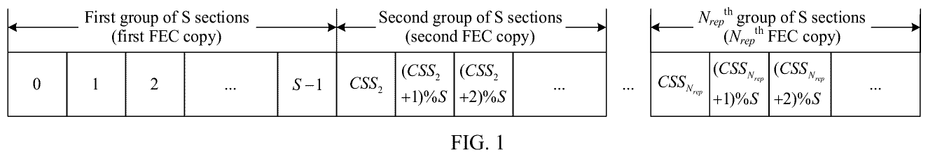

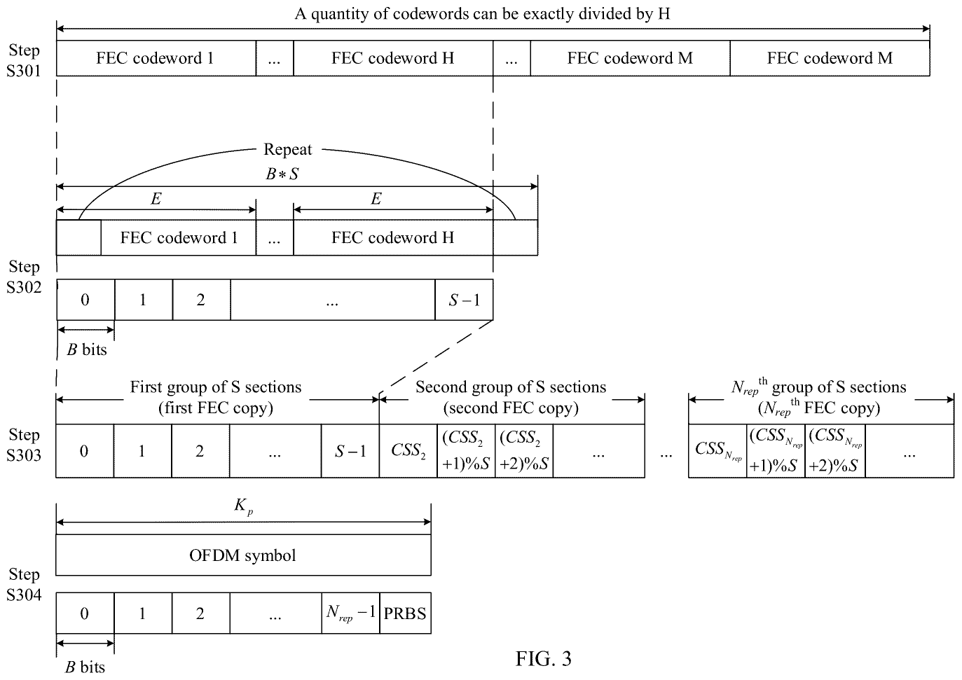

An FEC codeword 1 (codeword_1), an FEC codeword 2 (codeword_2), . . . , and an FEC codeword M (codeword_M) that are generated after rate matching may be mapped to an OFDM symbol by using the following steps shown in FIG. 3:
Step S301: Repeat a final codeword in the M codewords for a plurality of times, so that a quantity of codewords can be exactly divided by H. In other words, the quantity of codewords may be H×M₂, where M₂ is a positive integer. Each codeword includes E bits.
The H×M₂ codewords are divided into M₂ groups. Each group includes H codewords. For any group of H codewords, the following step S302 to step S304 may be performed. The following uses a first group of H codewords as an example for description.
Step S302: Concatenate the H codewords, and place the concatenated H×E bits into a cyclic buffer;
   repeatedly concatenate first B×S−H×E bits of the H codewords at an end of the H codewords; and
   read B×S bits from the cyclic buffer, to generate one group including S sections whose index numbers are 0 to S−1, where each section includes B bits.
Step S303: Repeat the first group of S sections generated based on the first group of H codewords for Nᵣₑₚ times, and perform cyclic shift based on a corresponding CSS parameter in each repetition, to obtain Nᵣₑₚ×S sections. For specific implementations of repetition and cyclic shift, refer to the embodiment corresponding to FIG. 1 mentioned in the background. Details are not described herein again.
Step S304: Map Kₚ bits to one OFDM symbol, where the Kₚ bits include Nᵣₑₚ×B bits of Nᵣₑₚ sections and Kₚ−B×Nᵣₑₚ bits of a pseudo random sequence (pseudo random N binary sequence, PRBS).

It should be noted that the CSS parameter in step S303 may be obtained by querying a table. For example, a program for providing a CSS parameter lookup table is as follows:

```
  if(Nrep == 2) {
      if(S % 2 == 0){
        CSS[0] = 0; CSS[1] = 1;
      }else{
        CSS[0] = 0; CSS[1] = 0;
      }
    }else if(Nrep == 3){
      if (S % 3 == 0){
        CSS[0] = 0; CSS[1] = 1; CSS[2] = 2;
      }else{
        CSS[0] = 0; CSS[1] = 0; CSS[2] = 0;
      }
    }else if(Nrep == 4){
      if(S % 4 == 0){
        CSS[0] = 0; CSS[1] = 1; CSS[2] = 2; CSS[3] = 3;
      }else if(S % 2 == 0){
        CSS[0] = 0; CSS[1] = 0; CSS[2] = 1; CSS[3] = 1;
      }else{
        CSS[0] = 0; CSS[1] = 0; CSS[2] = 0; CSS[3] = 0;
      }
    }else if(Nrep == 5){
      if(S % 5 == 0){
        CSS[0] = 0; CSS[1] = 1; CSS[2] = 2; CSS[3] = 3; CSS[4] = 4;
      }else{
        CSS[0] = 0; CSS[1] = 0; CSS[2] = 0; CSS[3] = 0; CSS[4] = 0;
      }
    }else if(Nrep == 6){
      if(S % 6 == 0){
        CSS[0] = 0; CSS[1] = 1; CSS[2] = 2; CSS[3] = 3; CSS[4] = 4; CSS[5] = 5;
      }else if (S % 3 == 0){
        CSS[0] = 0; CSS[1] = 0; CSS[2] = 1; CSS[3] = 1; CSS[4] = 2; CSS[5] = 2;
      }else if (S % 2 == 0){
        CSS[0] = 0; CSS[1] = 0; CSS[2] = 0; CSS[3] = 1; CSS[4] = 1; CSS[5] = 1;
      }else{
        CSS[0] = 0; CSS[1] = 0; CSS[2] = 0; CSS[3] = 0; CSS[4] = 4; CSS[5] = 0;
      }
    }else if(Nrep == 7){
      if(S % 7 == 0){
        CSS[0] = 0; CSS[1] = 1; CSS[2] = 2; CSS[3] = 3; CSS[4] = 4; CSS[5] = 5;
CSS[6] = 6;
      }else{
        CSS[0] = 0; CSS[1] = 0; CSS[2] = 0; CSS[3] = 0; CSS[4] = 0; CSS[5] = 0;
CSS[6] = 0;
      }
    }else if (Nrep == 8){
      if (S % 8 == 0){
        CSS[0] = 0; CSS[1] = 1; CSS[2] = 2; CSS[3] = 3;
        CSS[4] = 4; CSS[5] = 5; CSS[6] = 6; CSS[7] = 7;
      }else if (S % 4 == 0){
        CSS[0] = 0; CSS[1] = 0; CSS[2] = 1; CSS[3] = 1;
        CSS[4] = 2; CSS[5] = 2: CSS[6] = 3; CSS[7] = 3;
      }else if (S % 2 == 0){
        CSS[0] = 0; CSS[1] = 0; CSS[2] = 0; CSS[3] = 0;
        CSS[4] = 1; CSS[5] = 1; CSS[6] = 1; CSS[7] = 1;
      }else{
        CSS[0] = 0; CSS[1] = 0; CSS[2] = 0; CSS[3] = 0;
        CSS[4] = 0; CSS[5] = 0; CSS[6] = 0; CSS[7] = 0;
      }
  }else{
      CSS[0] = 0; CSS[1] = 0; CSS[2] = 0; CSS[3] = 0;
      CSS[4] = 0; CSS[5] = 0; CSS[6] = 0; CSS[7] = 0;
  }
```

### 3. Problems of an Existing RCM Solution

As described in the background, in the foregoing RCM, pulse interference that may be received in a transmission process can be resisted only by repeating, for Nᵣₑₚ times, S sections of a codeword that has undergone rate matching, and performing cyclic shift based on a corresponding CSS parameter in each repetition. For example, a correspondence between Nᵣₑₚ and a CC gain that can be obtained by a receive end may be shown in the following Table 1:

TABLE 1

| Nᵣₑₚ | 1 | 2 | 4 | 6 | 8 | 10 | 12 |
|---|---|---|---|---|---|---|---|
| CC gain relative to | 0 | 3.0 | 6.0 | 7.8 | 9.0 | 10.0 | 10.8 |
| Nᵣₑₚ = 1 (unit: dB) | | | | | | | |

It can be learned from Table 1 that, with an increase of Nᵣₑₚ, an increase of the CC gain gradually slows down, and a value of the CC gain is limited.

For a problem that the CC gain is limited in the existing RCM solution, an encoding gain can be increased in this embodiment of this application, so that the receive end can correctly recover source data with a higher probability, thereby improving reliability of an entire system.

The following describes the technical solutions in embodiments of this application with reference to the accompanying drawings in embodiments of this application. In the descriptions of this application, unless otherwise specified, “/” indicates that associated objects are in an “or” relationship. For example, A/B may represent A or B. In this application, “and/or” describes only an association relationship between associated objects and represents that three relationships may exist. For example, A and/or B may indicate: Only A exists, both A and B exist, and only B exists, where A and B may be singular or plural. In addition, in the descriptions of this application, “a plurality of” means two or more than two unless otherwise specified. “At least one of the following items (pieces)” or a similar expression thereof means any combination of these items, including any combination of singular items (pieces) or plural items (pieces). For example, at least one item (piece) of a, b, or c may indicate: a, b, c, a and b, a and c, b and c, or a, b, and c, where a, b, and c may be singular or plural. In addition, to clearly describe the technical solutions in embodiments of this application, terms such as first and second are used in embodiments of this application to distinguish between same items or similar items that provide basically same functions or purposes. A person skilled in the art may understand that the terms such as “first” and “second” do not limit a quantity or an execution order, and the terms such as “first” and “second” do not indicate a definite difference. In addition, in embodiments of this application, terms such as “example” or “for example” are used to represent giving an example, an illustration, or a description. Any embodiment or design scheme described as an “example” or “for example” in embodiments of this application should not be explained as being more preferred or having more advantages than another embodiment or design scheme. Exactly, use of the terms such as “example” or “for example” is intended to present a related concept in a specific manner for ease of understanding.

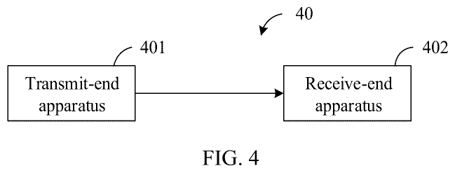

FIG. 4 shows a communication system 40 according to an embodiment of this application. The communication system 40 includes a transmit-end apparatus 401 and a receive-end apparatus 402. The transmit-end apparatus 401 is configured to perform bit mapping on kᵣᵥ₁ information source bits whose reliability is lower than a first threshold in a first bit sequence, to obtain a second bit sequence. The first bit sequence is a bit sequence obtained by performing bit mapping after CRC bits are added to the information source bit sequence. The kᵣᵥ₁ information source bits are bits in the information source bit sequence. A length of the first bit sequence is equal to a length of the second bit sequence. The transmit-end apparatus 401 is further configured to: perform an exclusive OR operation on bits in a bit sequence obtained by encoding the first bit sequence and bits in a bit sequence obtained by encoding the second bit sequence, to obtain a third bit sequence; and map, to an OFDM symbol, the third bit sequence and the bit sequence obtained by encoding the first bit sequence. Alternatively, the transmit-end apparatus 401 is further configured to map, to an OFDM symbol, the third bit sequence and the bit sequence obtained by encoding the first bit sequence, where the third bit sequence and the second bit sequence are the same bit sequence. Specific implementation and technical effects of the solution are described in detail in subsequent method embodiments, and details are not described herein again. The transmit-end apparatus 401 is further configured to send a wireless signal to the receive-end apparatus 402. Correspondingly, the receive-end apparatus 402 is configured to: receive the wireless signal from the transmit-end apparatus 401, and recover the information source bit sequence based on the received wireless signal.

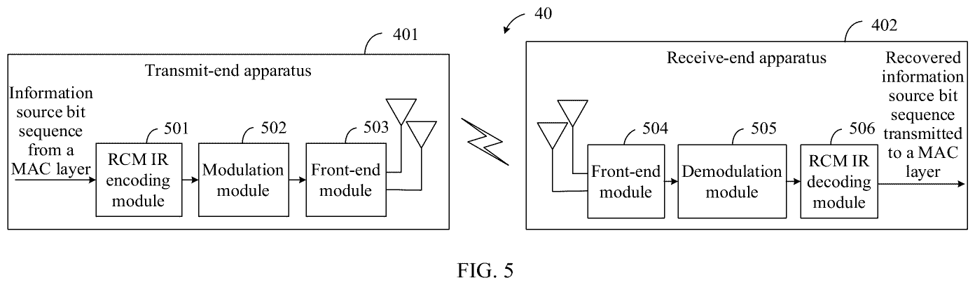

FIG. 5 shows a specific example of a communication system 40 according to an embodiment of this application.

In the transmit-end apparatus 401, the information source bit sequence from a medium access control (medium access control, MAC) layer is processed by an RCM incremental redundancy (incremental redundancy, IR) encoding module 501, a modulation module 502, and a front-end module 503, and then becomes the wireless signal to be sent by a transmit-end antenna. The RCM IR encoding module 501 is configured to map the information source bit sequence to the OFDM symbol. For a specific processing procedure, refer to the encoding method provided in embodiments of this application. The modulation module 502 is configured to convert, into a high-frequency signal suitable for channel transmission, a baseband signal output by the RCM IR encoding module 501. A modulation scheme may be, for example, 64 quadrature amplitude modulation (64 quadrature amplitude modulation, 64QAM). This is not limited in this embodiment of this application. The front-end module 503 may also be referred to as a radio frequency module, and is configured to convert, into a wireless signal, a signal output by the modulation module 502.

In the receive-end apparatus 402, the received wireless signal is processed by a front-end module 504, a demodulation module 505, and an RCM IR decoding module 506, and a recovered information source bit sequence is transmitted to a MAC layer. The front-end module 504 may also be referred to as a radio frequency module, and is configured to convert the received wireless signal into a wired signal. The demodulation module 505 is configured to generate log-likelihood ratio (log-likelihood ratio, LLR) soft information based on the signal output by the front-end module 504. The RCM IR decoding module 506 is configured to recover the information source bit sequence based on the LLR soft information.

It should be noted that, due to impact such as channel noise, it is very likely that the information source bit sequence in the transmit-end apparatus 401 is different from the information source bit sequence recovered in the receive-end apparatus 402. This application is intended to improve a similarity between the two sequences, even if there are more same bits between the two sequences.

Optionally, a related function of the transmit-end apparatus in this embodiment of this application may be implemented by one device, or may be jointly implemented by a plurality of devices, or may be implemented by one or more functional modules in one device. This is not specifically limited in this embodiment of this application. It may be understood that the foregoing function may be a network element in a hardware device, a software function running on dedicated hardware, a combination of hardware and software, or a virtualized function instantiated on a platform (for example, a cloud platform).

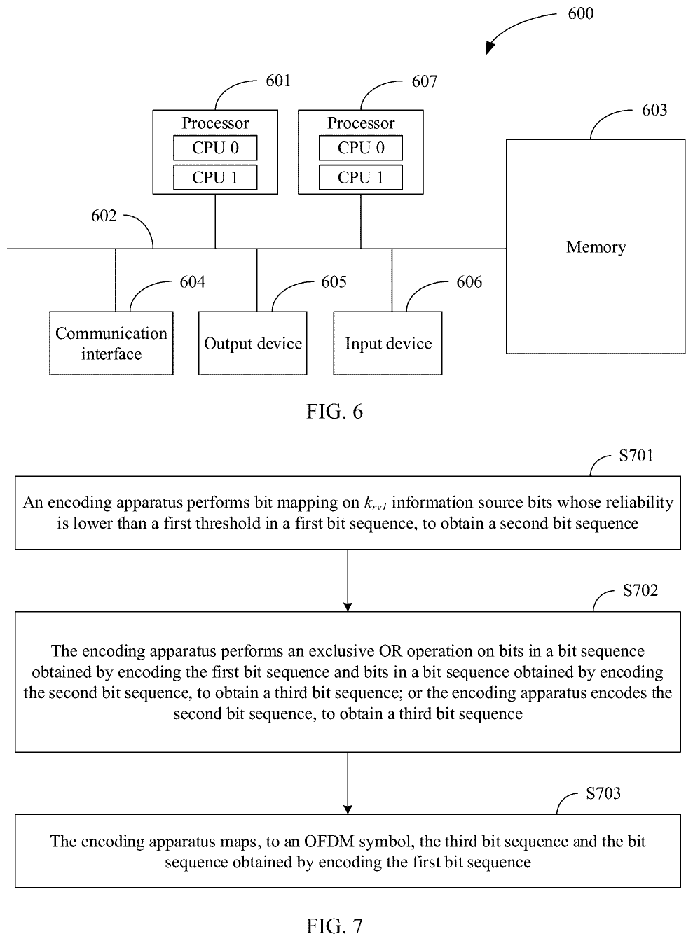

For example, related functions of the transmit-end apparatus in this embodiment of this application may be implemented by a communication apparatus 600 in FIG. 6.

FIG. 6 is a diagram of a structure of the communication apparatus 600 according to an embodiment of this application. The communication apparatus 600 includes one or more processors 601, a communication line 602, and at least one communication interface (in FIG. 6, an example in which a communication interface 604 and one processor 601 are included is merely used for illustration). Optionally, a memory 603 may be further included.

The processor 601 may be a CPU, a microprocessor, an application-specific integrated circuit (application-specific integrated circuit, ASIC), or one or more integrated circuits configured to control program execution of the solutions of this application.

The communication line 602 may include a path, configured to connect different components.

The communication interface 604 may be a transceiver module, configured to communicate with another device or a communication network, for example, Ethernet, a RAN, or a WLAN. For example, the transceiver module may be an apparatus such as a transceiver or a transceiver machine. Optionally, the communication interface 604 may be alternatively a transceiver circuit located in the processor 601, to implement signal input and signal output of the processor.

The memory 603 may be an apparatus having a storage function. The memory 603 may be a read-only memory (read-only memory, ROM), another type of static storage device that can store static information and an instruction, a random access memory (random access memory, RAM), or another type of dynamic storage device that can store information and an instruction, or may be an electrically erasable programmable read-only memory (electrically erasable programmable read-only memory, EEPROM), a compact disc read-only memory (compact disc read-only memory, CD-ROM) or another compact disc storage, an optical disc storage (including a compact disc, a laser disc, an optical disc, a digital versatile disc, a Blu-ray disc, or the like), a magnetic storage medium or another magnetic storage device, or any other medium that can be used to carry or store expected program code in a form of an instruction or a data structure and that can be accessed by a computer. However, this is not limited thereto. The memory may exist independently, and is connected to the processor through the communication line 602. The memory may be alternatively integrated with the processor.

The memory 603 is configured to store computer-executable instructions for performing the solutions in this application, and the processor 601 controls execution. The processor 601 is configured to execute the computer-executable instructions stored in the memory 603, to implement the encoding method provided in embodiments of this application.

Alternatively, in this embodiment of this application, the processor 601 may implement a processing-related function in the encoding method provided in the following embodiments of this application, and the communication interface 604 may be responsible for communicating with the another device or the communication network. This is not specifically limited in this embodiment of this application.

The computer-executable instructions in this embodiment of this application may also be referred to as application program code. This is not specifically limited in this embodiment of this application.

During specific implementation, in an embodiment, the processor 601 may include one or more CPUs, for example, a CPU 0 and a CPU 1 in FIG. 6.

During specific implementation, in an embodiment, the communication apparatus 600 may include a plurality of processors, for example, the processor 601 and a processor 607 in FIG. 6. Each of the processors may be a single-core (single-CPU) processor, or may be a multi-core (multi-CPU) processor. The processor herein may be one or more devices, circuits, and/or processing cores configured to process data (for example, computer program instructions).

During specific implementation, in an embodiment, the communication apparatus 600 may further include an output device 605 and an input device 606. The output device 605 communicates with the processor 601, and may display information in a plurality of manners.

The communication apparatus 600 may be a general-purpose apparatus or a dedicated apparatus. For example, the communication apparatus 600 may be a desktop computer, a portable computer, a network server, a palmtop computer (personal digital assistant, PDA), a mobile phone, a tablet computer, a wireless terminal apparatus, an in-vehicle terminal apparatus, an embedded device, or a device having a structure similar to that in FIG. 6. A type of the communication apparatus 600 is not limited in this embodiment of this application.

The following describes in detail the encoding method provided in embodiments of this application with reference to FIG. 1 to FIG. 6.

FIG. 7 shows an encoding method according to an embodiment of this application. The encoding method includes the following steps.

S701: An encoding apparatus performs bit mapping on kᵣᵥ₁ information source bits whose reliability is lower than a first threshold in a first bit sequence, to obtain a second bit sequence. The first bit sequence is a bit sequence obtained by performing bit mapping after CRC bits are added to the information source bit sequence. The kᵣᵥ₁ information source bits are bits in the information source bit sequence. A length of the first bit sequence is equal to a length of the second bit sequence.

In this embodiment of this application, vᵢ^{j} represents a sequence vᵢ^{j}={vᵢ, vᵢ₊₁, vᵢ₊₂, . . . , vⱼ} with a length of max(j−i+1,0). When j<i, the sequence is empty ∅. This is uniformly described herein. Details are not described below again.

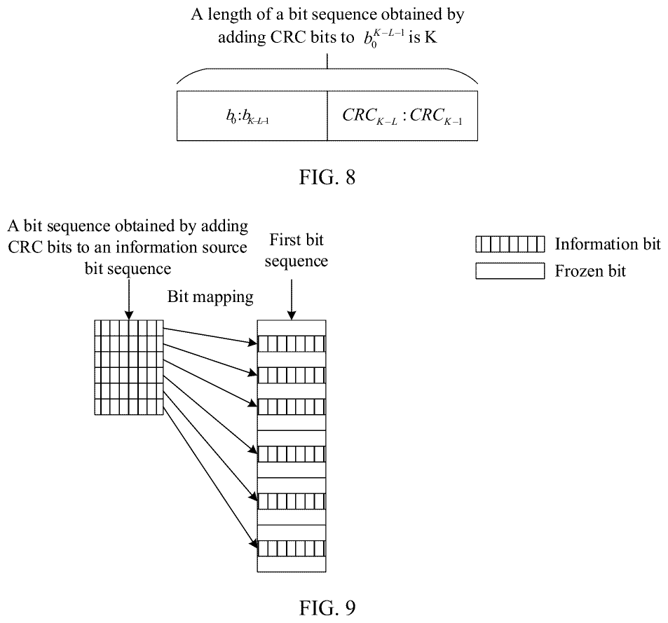

For example, the information source bit sequence is b₀^{K-L-1}. FIG. 8 shows a process of adding CRC bits to the information source bit sequence b₀^{K-L-1} by the encoding apparatus. The information source bit sequence b₀^{K-L-1} includes bits b₀, b₁, . . . , and b_{K-L-1}. The encoding apparatus may add CRC bits CRC_{K-L}, CRC_{K-L+1}, and CRC_{K-1} after the bit b_{K-L-1}, to form a bit sequence v₀^{K-1} with a length of K. The encoding apparatus adds the CRC bits to the information source bit sequence b₀^{K-L-1}, so that a receive-end apparatus can use a CRC-aided successive cancellation list (CRC-aided successive cancellation list, CA-SCL) algorithm to improve decoding performance.

For example, FIG. 9 shows a process in which the encoding apparatus performs bit mapping on the bit sequence v₀^{K-1} to obtain the first bit sequence. Specifically, the encoding apparatus maps the bit sequence v₀^{K-1} and one or more bits with a fixed value to a bit sequence with a length of N, that is, the first bit sequence uᵣᵥ₀_{₀}^{N-1}. The one or more bits with the fixed value may be a bit “0” or a bit “1”. These bits with the fixed value may be referred to as frozen bits because these bits do not carry any information. Correspondingly, because the bit sequence v₀^{K-1} carries information, the bit sequence v₀^{K-1} may be referred to as an information bit. In the embodiment shown in FIG. 8, the bit sequence v₀^{K-1} includes the information source bit sequence b₀^{K-L-1} and the CRC bits.

It should be noted that an index of a bit in the first bit sequence uᵣᵥ₀_{₀}^{N-1} has corresponding reliability, and an error is more likely to occur when a bit carried with a bit index corresponding to low reliability is decoded at a receive end. A reliability measure table used for recording a correspondence between a bit index and reliability may be preset according to a protocol. During bit mapping, an information bit in the bit sequence v₀^{K-1} may be preferentially mapped to a bit index corresponding to high reliability.

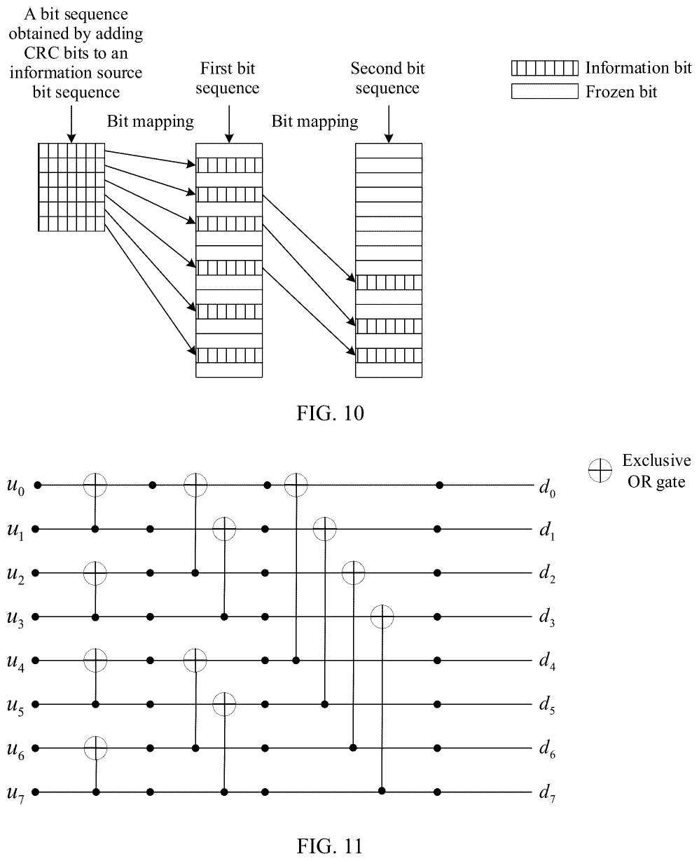

With reference to FIG. 9, FIG. 10 shows a process in which the encoding apparatus generates the second bit sequence. As described above, the first bit sequence uᵣᵥ₀_{₀}^{N-1} includes the information source bits, the CRC bits, and the frozen bits. The encoding apparatus may perform bit mapping on the kᵣᵥ₁ information source bits whose reliability is lower than the first threshold in the first bit sequence uᵣᵥ₀_{₀}^{N-1}, to obtain the second bit sequence uᵣᵥ₀_{₀}^{N-1}.

Optionally, Kᵣᵥ₁ bits whose reliability is higher than a second threshold in the second bit sequence are obtained by adding Lᵣᵥ₁ CRC bits to the kᵣᵥ₁ information source bits whose reliability is lower than the first threshold in the first bit sequence, where Kᵣᵥ₁=kᵣᵥ₁+L^{rv1}, kᵣᵥ₁, Lᵣᵥ₁, and Kᵣᵥ₁ are positive integers. In this solution, the Lᵣᵥ₁ CRC bits are added to the kᵣᵥ₁ information source bits whose reliability is lower than the first threshold in the first bit sequence, to check whether an error occurs in a transmission process of the kᵣᵥ₁ information source bits, thereby improving accuracy of recovering source data by the receive-end apparatus.

It is assumed that an available physical resource in FIG. 10 is Eᵣᵥ₁ bits, an expected bit rate is Rᵣᵥ₁, and Rᵣᵥ₁ satisfies

$${R}_{r v 1} ≪ \frac{{K}_{r v o}}{{E}_{r v o}} ,$$

to ensure reliability of performing bit mapping on the kᵣᵥ₁ information source bits. In this case, a quantity of information bits in the second bit sequence uᵣᵥ₁₀^{N-1} is Kᵣᵥ₁=kᵣᵥ₁+Lᵣᵥ₁=┌Eᵣᵥ₁×Rᵣᵥ₁┐+Lᵣᵥ₁. Herein, << represents far less than, ┌·┐ represents rounding up, and the expected bit rate Rᵣᵥ₁ may be obtained through simulation or may be an empirical value.

It should be noted that, to make the accompanying drawings more concise and intuitive, FIG. 10 does not show a process in which the encoding apparatus adds the Lᵣᵥ₁ CRC bits to the kᵣᵥ₁ information source bits whose reliability is lower than the first threshold in the first bit sequence uᵣᵥ₀_{₀}^{N-1}.

S702: The encoding apparatus performs an exclusive OR operation on bits in a bit sequence obtained by encoding the first bit sequence and bits in a bit sequence obtained by encoding the second bit sequence, to obtain a third bit sequence; or the encoding apparatus encodes the second bit sequence, to obtain a third bit sequence.

In this embodiment of this application, because the length of the first bit sequence is equal to the length of the second bit sequence, lengths of the two bit sequences obtained by respectively encoding the first bit sequence and the second bit sequence by using a same encoder are also equal.

In this embodiment of this application, the encoder may be, for example, a polar (polar) code encoder. For example, the encoding apparatus may perform a Kronecker product (Kronecker product) operation on the first bit sequence uᵣᵥ₀_{₀}^{N-1} with a length of N, to obtain an encoded bit sequence dᵣᵥ₀_{₀}^{N-1}. Specifically, dᵣᵥ₀_{₀}^{N-1} may satisfy the following Formula (1):

$${d}_{rv {0}_{0}}^{N - 1} = {u}_{rv {0}_{0}}^{N - 1} {G}_{N} \qquad Formula ( 1 )$$

Herein, N=2″, n is a positive integer, N represents the length of the first bit sequence or the length of the bit sequence obtained by encoding the first bit sequence,

$${G}_{N} = {F}^{⊗ n} , F = [ \begin{matrix}1 & 0 \\ 1 & 1\end{matrix} ] ,$$

⊗n represents an n-order Kronecker product, and G_{N} represents a generator matrix of N×N.

The following describes a polar code encoding process by using an example in which the first bit sequence uᵣᵥ₀_{₀}^{N-1} is {u₀, u₁, u₂, . . . , v₇}, that is, N=8.

As shown in FIG. 11, a first encoded bit is d₀=u₀⊕u₁⊕u₂⊕u₃⊕u₄⊕u₅⊕u₆⊕u₇, a second encoded bit is d₁=u₁⊕u₃⊕u₅⊕u₇, a third encoded bit is d₂=u₂⊕u₃⊕u₆⊕u₇, a fourth encoded bit is d₃=u₃⊕u₇, a fifth encoded bit is, d₄=u₄⊕u₅⊕u₆⊕u₇, a sixth encoded bit is d₅=u₅⊕u₇, a seventh encoded bit is d₆=u₆⊕u₇, and an eighth encoded bit is d₇=u₇, Herein, ⊕ represents an exclusive OR operation.

For example, the encoding apparatus may encode the second bit sequence uᵣᵥ₁_{₀}^{N-1}, to obtain the third bit sequence dᵣᵥ₁_{₀}^{N-1}. For a specific encoding manner, refer to the foregoing manner of encoding the first bit sequence uᵣᵥ₀_{₀}^{N-1}. Details are not described herein again.

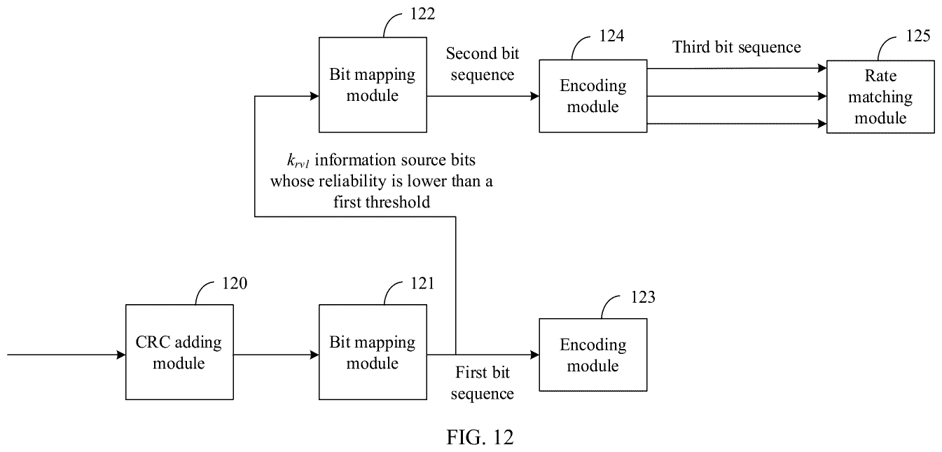

FIG. 12 shows a manner of generating the third bit sequence. After being processed by a CRC adding module 120, the information source bit sequence may be used as an input of a bit mapping module 121. An output of the bit mapping module 121 is the first bit sequence. For a specific implementation of bit mapping, refer to the embodiment shown in FIG. 9. The encoding apparatus inputs, to a bit mapping module 122, the kᵣᵥ₁ information source bits whose reliability is lower than the first threshold in the first bit sequence, and an output of the bit mapping module 122 is the second bit sequence. Alternatively, the encoding apparatus adds the CRC bits to the kᵣᵥ₁ information source bits whose reliability is lower than the first threshold in the first bit sequence, and then performs inputting to a bit mapping module 122, and an output of the bit mapping module 122 is the second bit sequence. For a specific implementation of bit mapping, refer to the embodiment shown in FIG. 10. The encoding apparatus inputs the first bit sequence to an encoding module 123, and inputs the second bit sequence to the encoding module 124. An output of the encoding module 124 is the third bit sequence. The third bit sequence may be used as an input of a rate matching module 125. The rate matching module 125 is configured to perform rate matching on the bit sequence. For a specific function, refer to related descriptions in the following step S703. Details are not described herein.

For example, the encoding apparatus may encode the first bit sequence uᵣᵥ₀_{₀}^{N-1}, to obtain the bit sequence dᵣᵥ₀_{₀}^{N-1}. The encoding apparatus may further encode the second bit sequence uᵣᵥ₁_{₀}^{N-1}, to obtain a bit sequence dₜₘₚ_{₀}^{N-1}. The encoding apparatus may perform an exclusive OR operation on bits in the bit sequence dᵣᵥ₀_{₀}^{N-1} and bits in the bit sequence dₜₘₚ_{₀}^{N-1}, to obtain the third bit dᵣᵥ₁_{₀}^{N-1}. In other words, dᵣᵥ₁_{₀}^{N-1} may satisfy the following Formula (2):

$${d}_{r ν {1}_{0}}^{N - 1} = mod ( {d}_{{tmp}_{0}}^{N - 1} + {d}_{rv {0}_{0}}^{N - 1} , 2 ) \qquad Formula ( 2 )$$

Herein, mod() represents a modulo operation.

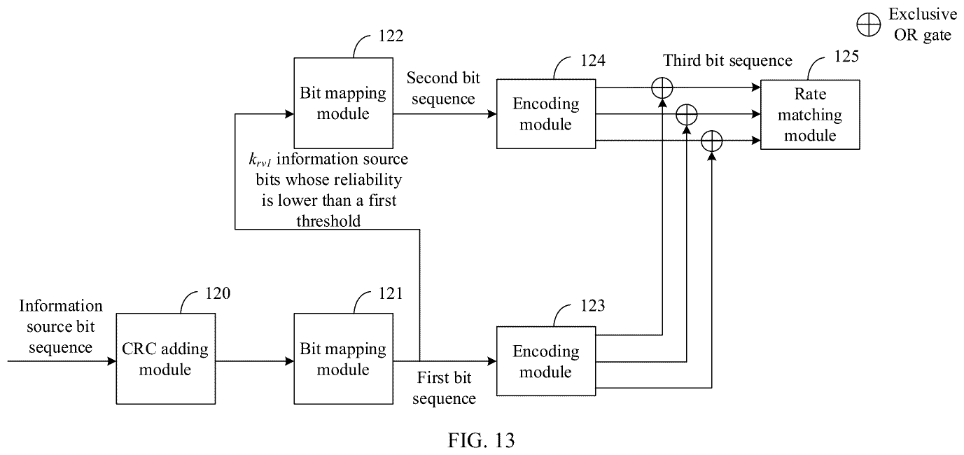

For example, FIG. 13 shows another manner of generating the third bit sequence. After being processed by a CRC adding module 120, the information source bit sequence may be used as an input of a bit mapping module 121. An output of the bit mapping module 121 is the first bit sequence. For a specific implementation of bit mapping, refer to the embodiment shown in FIG. 9. The encoding apparatus inputs, to a bit mapping module 122, the kᵣᵥ₁ information source bits whose reliability is lower than the first threshold in the first bit sequence, and an output of the bit mapping module 122 is the second bit sequence. Alternatively, the encoding apparatus adds the CRC bits to the kᵣᵥ₁ information source bits whose reliability is lower than the first threshold in the first bit sequence, and then performs inputting to a bit mapping module 122, and an output of the bit mapping module 122 is the second bit sequence. For a specific implementation of bit mapping, refer to the embodiment shown in FIG. 10. The encoding apparatus inputs the first bit sequence to an encoding module 123, inputs the second bit sequence to an encoding module 124, and performs an exclusive OR operation on bits in two encoded bit sequences, to obtain the third bit sequence. The third bit sequence may be used as an input of a rate matching module 125. The rate matching module 125 is configured to perform rate matching on the bit sequence. For a specific function, refer to related descriptions in the following step S703. Details are not described herein.

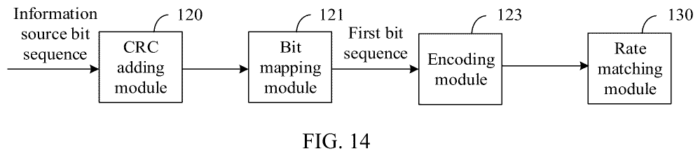

For example, FIG. 14 shows a manner of generating and processing the first bit sequence. After being processed by a CRC adding module 120, the information source bit sequence may be used as an input of a bit mapping module 121. An output of the bit mapping module 121 is the first bit sequence. For a specific implementation of bit mapping, refer to the embodiment shown in FIG. 9. The first bit sequence may also be used as an input of an encoding module 123. The bit sequence obtained by encoding the first bit sequence by the encoding apparatus may be used as an input of a rate matching module 130. The rate matching module 130 is configured to perform rate matching on the bit sequence. For a specific function, refer to related descriptions in the following step S703. Details are not described herein.

S703: The encoding apparatus maps, to an OFDM symbol, the third bit sequence and the bit sequence obtained by encoding the first bit sequence.

For a same information source bit sequence, the second bit sequence is introduced in the encoding method provided in this embodiment of this application, so that the third bit sequence and the bit sequence obtained by encoding the first bit sequence can be mapped to the OFDM symbol. This is different from a prior-art solution of directly encoding the first bit sequence and performing mapping to the OFDM symbol. Apparently, in this embodiment of this application, for the same information source bit sequence, the bit sequence obtained by encoding the first bit sequence is obtained, and more encoded codewords, that is, the third bit sequence, may be obtained. If a signal is affected by pulse interference in a transmission process, a proportion of an erroneous codeword in all codewords is smaller than that in the conventional technologies. In other words, in this embodiment of this application, more redundant information is introduced, so that a receive-end apparatus can correctly recover source data at a higher probability, thereby improving an encoding gain and improving reliability of an entire system. In addition, in this embodiment of this application, the kᵣᵥ₁ information source bits whose reliability is lower than the first threshold may be selected from the first bit sequence to generate the second bit sequence. Because a bit with low reliability is more likely to encounter an error when the receive-end apparatus performs decoding, the second bit sequence is generated by using the kᵣᵥ₁ information source bits, and the second bit sequence is further encoded to obtain the third bit sequence. In this way, decoding performance of the receive-end apparatus can be enhanced.

Optionally, step S703 includes: The encoding apparatus performs rate matching on the bit sequence obtained by encoding the first bit sequence, then performs segmentation to obtain M₁ groups of S sections, and performs the following operations on an x₁^{th} group of S sections: The encoding apparatus repeats the x₁^{th} group of S sections for Nᵣᵥ₀ times, and performs cyclic shift based on a corresponding CSS parameter in each repetition, to obtain Nᵣᵥ₀×S sections, where M₁, S, x₁, and Nᵣᵥ₀ are all positive integers, and 1≤x₁≤M₁. The encoding apparatus performs rate matching on the third bit sequence, then performs segmentation to obtain M₁ groups of S sections, and performs the following operations on an x₂^{th} group of S sections: The encoding apparatus repeats the x₂^{th} group of S sections for Nᵣᵥ₁ times, and performs cyclic shift based on a corresponding CSS parameter in each repetition, to obtain Nᵣᵥ₁×S sections, where x₂ and Nᵣᵥ₁ are both positive integers, and 1≤x₂≤M₁. The encoding apparatus sequentially concatenates the sections, Nᵣᵥ₀×S sections and the Nᵣᵥ₁×S sections, and performs mapping to the OFDM symbol; or the encoding apparatus concatenates the Nᵣᵥ₀×S sections and the Nᵣᵥ₁×S sections in an interleaving manner in a unit of a section, and performs mapping to the OFDM symbol. In this solution, segmentation, repetition, cyclic shift, and combination are appropriately performed on the third bit sequence and the bit sequence obtained by encoding the first bit sequence, and then mapping is performed to the OFDM symbol, so that more encoded codewords are carried on the same OFDM symbol.

In this embodiment of this application, rate matching may include sub-block interleaving (sub-block interleaver), bit selection (bit selection), and bit interleaving (bit interleaver).

With reference to the foregoing Formula (1), the bit sequence obtained by encoding the first bit sequence uᵣᵥ₀_{₀}^{N-1} by the encoding apparatus is dᵣᵥ₀_{₀}^{N-1}, where dᵣᵥ₀_{₀}^{N-1}={d₀,d₁, . . . ,d_{N-1}} may be used as an input bit sequence for sub-block interleaving. The encoding apparatus may divide dᵣᵥ₀_{₀}^{N-1} into m sub-blocks for interleaving. An interleaved bit sequence is yᵣᵥ₀_{₀}^{N-1}={y₀, y₁, . . . , y_{N-1}}.

For example, pseudo code for sub-block interleaving of polar code may be as follows:

1. f or n = 0: N − 1
2. i = └m × n/N┘
3. J(n) = P(i) × (N/m) + mod (n, N/m)
4. yₙ = d_{J}(n)
5. end f or

When m=32, a sub-block interleaving pattern may be shown in Table 2.

TABLE 2

| i | P(i) | i | P(i) | i | P(i) | i | P(i) | i | P(i) | i | P(i) | i | P(i) | i | P(i) |
|---|---|---|---|---|---|---|---|---|---|---|---|---|---|---|---|
| 0 | 0 | 4 | 3 | 8 | 8 | 12 | 10 | 16 | 12 | 20 | 14 | 24 | 24 | 28 | 27 |
| 1 | 1 | 5 | 5 | 9 | 16 | 13 | 18 | 17 | 20 | 21 | 22 | 25 | 25 | 29 | 29 |
| 2 | 2 | 6 | 6 | 10 | 9 | 14 | 11 | 18 | 13 | 22 | 15 | 26 | 26 | 30 | 30 |
| 3 | 4 | 7 | 7 | 11 | 17 | 15 | 19 | 19 | 21 | 23 | 23 | 27 | 28 | 31 | 31 |

Herein, i represents a sub-block index after interleaving, and P(i) is a sub-block index, before interleaving, that corresponds to the sub-block index i after interleaving.

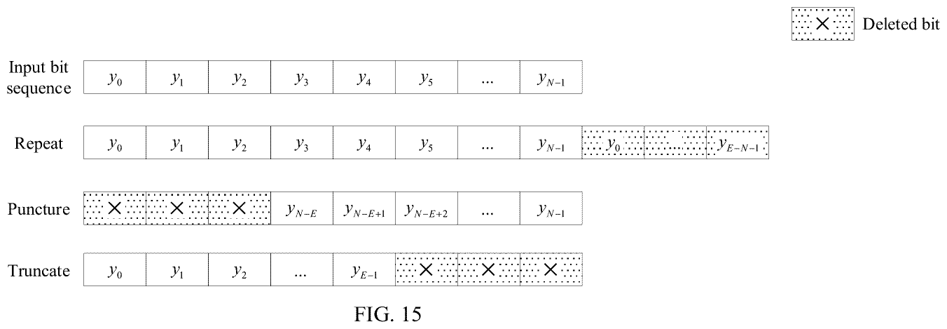

For example, FIG. 15 shows a bit selection process. An input of bit selection may be the bit sequence yᵣᵥ₀_{₀}^{N-1}={y₀, y₁, . . . , y_{N-1}} obtained after sub-block interleaving. An output obtained through repetition, puncturing, or truncation is a bit sequence eᵣᵥ₀_{₀}^{N-1}={e₀, e₁, . . . , e_{N-1}}. The repetition means repeating a bit sequence y₀, . . . , y_{E-N-1}, and concatenating the bit sequence y₀, . . . , y_{E-N-1}, after a bit sequence yᵣᵥ₀_{₀}^{N-1}. The puncturing means deleting a previous segment of bit sequence y₀, . . . , y_{E-N-1}, and reserving a current segment of bit sequence y_{N-E}, . . . , y_{N-1} as an output bit sequence. The truncation means deleting a current segment of bit sequence y_{E}, . . . , y_{N-1}, and reserving a previous segment of bit sequence y₀, . . . , y_{E-1} as an output bit sequence.

In this embodiment of this application, bit interleaving is used to enable a burst error generated on a channel to spread throughout time, and convert the burst error into a random error, so that the receive-end apparatus can perform error correction by using a common coding technology. An input of bit interleaving may be a bit sequence eᵣᵥ₀_{₀}^{N-1}={e₀, e₁, . . . , e_{N-1}} obtained through bit selection, and an output of the bit interleaving may be fᵣᵥ₀_{₀}^{N-1}={f₀, f₁, . . . , f_{N-1}}. Bit interleaving usually includes row-column interleaving and triangular interleaving.

For example, possible pseudo code of a row-column interleaver of X rows and Y columns is as follows, where Y=┌E/X┐, and ┌·┐ represents rounding up.

| | |
|---|---|
| 1. | k = 0 |
| 2. | for i = 0:X − 1 |
| 3. | for j = 0:┌E/X┐ − 1 |
| 4. | if k < E then |
| 5. | V_{i,j} = eₖ |
| 6. | else then |
| 7. | V_{i,j} = (NULL) |
| 8. | end if |
| 9. | k = k + 1 |
| 10. | end for |
| 11. | end for |
| 12. | k = 0 |
| 13. | for j = 0: ┌E/X┐ − 1 |
| 14. | for i = 0: X − 1 |
| 15. | if V_{i,j} ≠ (NULL) then |
| 16. | fₖ = V_{i,j} |
| 17. | k = k + 1 |
| 18. | end if |
| 19. | end for |
| 20. | end for |

Similarly, the encoding apparatus may further perform rate matching on the third bit sequence. For a specific implementation, refer to the foregoing manner of performing rate matching on the bit sequence obtained by encoding the first bit sequence. Details are not described herein again.

Optionally, that the encoding apparatus performs rate matching on the bit sequence obtained by encoding the first bit sequence, and then performs segmentation to obtain M₁ groups of S sections includes that the encoding apparatus performs division to obtain M codewords, after rate matching is performed on the bit sequence obtained by encoding the first bit sequence, where each codeword includes E bits; the encoding apparatus repeats a final codeword in the M codewords for a plurality of times, so that a quantity of codewords is H×M₂; the encoding apparatus divides the H×M₂ codewords into M₂ groups, where each group includes H codewords; and the encoding apparatus performs the following operations on an x₃^{th} group of H codewords: The encoding apparatus concatenates the H codewords, and places concatenated H×E bits into a first cyclic buffer; the encoding apparatus concatenates first B×S−H×E bits in the H codewords at an end of the H codewords, where H, E, M₂, and x₃ are all positive integers, 1≤x₃≤M₂, and B represents a quantity of bits in each section; and the encoding apparatus reads B×S bits from the cyclic buffer, to generate one group of S sections, where each section includes B bits. For a segmentation process, refer to step S301 and step S302 in the embodiment shown in FIG. 3. Details are not described herein again. This solution can improve compatibility with the conventional technologies.

Optionally, that the encoding apparatus performs rate matching on the third bit sequence, and then performs segmentation to obtain M₁ groups of S sections includes that the encoding apparatus performs division to obtain M codewords, after rate matching is performed on the third bit sequence, where each codeword includes E bits; the encoding apparatus repeats a final codeword in the M codewords for a plurality of times, so that a quantity of codewords is H×M₂; the encoding apparatus divides the H×M₂ codewords into M₂ groups, where each group includes H codewords; and the encoding apparatus performs the following operations on an x₃^{th} group of H codewords: The encoding apparatus concatenates the H codewords, and places concatenated H×E bits into a first cyclic buffer; the encoding apparatus concatenates first B×S−H×E bits in the H codewords at an end of the H codewords, where H, E, M₂, and x₃ are all positive integers, 1≤x₃≤M₂, and B represents a quantity of bits in each section; and the encoding apparatus reads B×S bits from the cyclic buffer, to generate one group of S sections, where each section includes B bits. For a segmentation process, refer to step S301 and step S302 in the embodiment shown in FIG. 3. Details are not described herein again. This solution can improve compatibility with the conventional technologies.

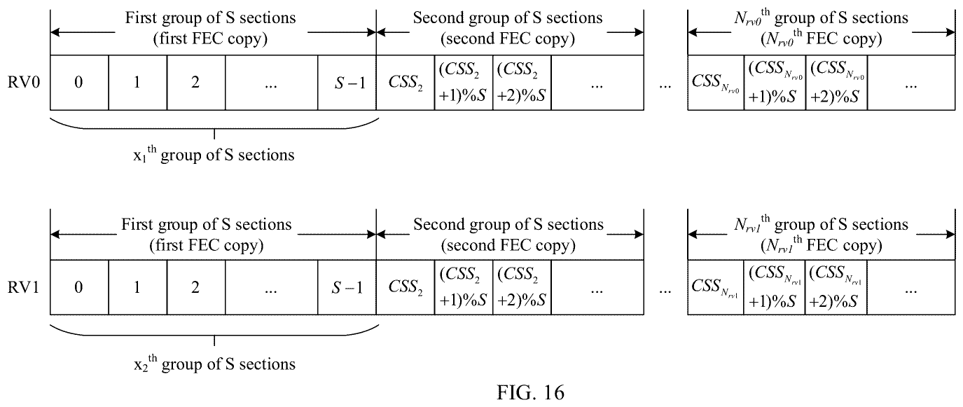

FIG. 16 shows a process of performing repetition and cyclic shift separately on the x₁^{th} group of S sections and the x₂^{th} group of S sections according to an embodiment of this application. The encoding apparatus repeats the x₁^{th} group of S sections for Nᵣᵥ₀ times, and performs cyclic shift based on a corresponding CSS parameter in each repetition, to obtain Nᵣᵥ₀×S sections, that is, RV0. The encoding apparatus repeats the x₂^{th} group of S sections for Nᵣᵥ₁ times, and performs cyclic shift based on a corresponding CSS parameter in each repetition, to obtain Nᵣᵥ₁×S sections, that is, RV1. The x₁^{th} group of S sections are obtained based on the bit sequence obtained by encoding the first bit sequence. The x₂^{th} group of S sections are obtained based on the third bit sequence. For a specific process of repetition and cyclic shift, refer to step S303 in the embodiment shown in FIG. 3. Details are not described herein again. In this embodiment of this application, a codeword repetition quantity Nᵣₑₚ in an existing RCM solution is split into N_{RV0} and N_{RV1}, and Nᵣₑₚ is equal to a sum of N_{RV0} and N_{RV1}. In other words, a quantity of repetitions of the x₁^{th} group of S sections obtained based on the bit sequence obtained by encoding the first bit sequence is N_{RV0}, and a quantity of repetitions of the x₂^{th} group of S sections obtained based on the third bit sequence is N_{RV1}.

In a possible implementation, the encoding apparatus may sequentially concatenate the Nᵣᵥ₀×S sections and the Nᵣᵥ₁×S sections, that is, [RV0, RV1], and perform mapping to the OFDM symbol.

In another possible implementation, the encoding apparatus may concatenate the Nᵣᵥ₀×S sections and the Nᵣᵥ₁×S sections in an interleaving manner in a unit of a section, that is, [RV0₀, RV1₀, RV0₁, RV1₁, . . . ] or [RV1₀, RV0₀, RV1₁, RV0₁, . . . ], and perform mapping to the OFDM symbol. Herein, RV0ᵢ represents a section whose index number is i in RV0, and RV1ᵢ represents a section whose index number is i in RV1.

Optionally, that the encoding apparatus performs rate matching on the bit sequence obtained by encoding the first bit sequence includes that the encoding apparatus performs bit interleaving on a fourth bit sequence, where the fourth bit sequence is a bit sequence obtained by performing sub-block interleaving and bit selection on the bit sequence obtained by encoding the first bit sequence by the encoding apparatus; and that the encoding apparatus performs rate matching on the third bit sequence includes that the encoding apparatus performs bit interleaving on a fifth bit sequence, where the fifth bit sequence is a bit sequence obtained by performing sub-block interleaving and bit selection on the third bit sequence by the encoding apparatus.

Optionally, the encoding method provided in embodiments of this application further includes: The encoding apparatus places a fourth bit sequence and a fifth bit sequence into a second cyclic buffer, where the fourth bit sequence is a bit sequence obtained by performing sub-block interleaving and bit selection on the bit sequence obtained by encoding the first bit sequence by the encoding apparatus, and the fifth bit sequence is a bit sequence obtained by performing sub-block interleaving and bit selection on the third bit sequence by the encoding apparatus. When the information source bit sequence is retransmitted, the encoding apparatus reads the bit sequence from an initial bit of the fourth bit sequence or the fifth bit sequence, and performs bit interleaving on the read bit sequence. In this solution, when the information source bit sequence is retransmitted, only a sequence in the second cyclic buffer needs to be read and then interleaved. In this case, steps of CRC addition, bit mapping, encoding, sub-block interleaving, and/or bit selection do not need to be performed again, to save software and hardware resources and time.

For example, the encoding apparatus performs sub-block interleaving and bit selection on the bit sequence obtained by encoding the first bit sequence, to obtain the fourth bit sequence eᵣᵥ₀_{₀}^{E}^{ᵣᵥ₀}⁻¹. Similarly, the encoding apparatus may further perform sub-block interleaving and bit selection on the third bit sequence, to obtain the fifth bit sequence eᵣᵥ₁_{₀}^{E}^{ᵣᵥ₁}⁻¹. In this case, the encoding apparatus may place the fourth bit sequence eᵣᵥ₀_{₀}^{N-1} and the fifth bit sequence eᵣᵥ₁_{₀}^{N-1} into the second cyclic buffer E_{b}, that is, E_{B}_{₀}^{E}^{ᵣᵥ₀}^{+E}^{ᵣᵥ₁}⁻¹={eᵣᵥ₀_{₀}^{E}^{ᵣᵥ₀}⁻¹, eᵣᵥ₁_{₀}^{E}^{ᵣᵥ₁}⁻¹}.

In this embodiment of this application, when the information source bit sequence is retransmitted, the encoding apparatus may read a part of the fourth bit sequence, the fourth bit sequence, the fourth bit sequence and a part of the fifth bit sequence, the fourth bit sequence and the fifth bit sequence, a part of the fifth bit sequence, or the fifth bit sequence from the second cyclic buffer based on an available physical resource. This is not limited in this embodiment of this application. A start location of a bit sequence, that is, a location of an initial bit in the bit sequence, may be shown in Table 3.

TABLE 3

| | | | | Bit sequence |
|---|---|---|---|---|
| Name | Fourth | | Bit sequence | 2 read |
| of a bit | bit | Fifth bit | 1 read during | during |
| sequence | sequence | sequence | retransmission | retransmission |
| Start location | 0 | Eᵣᵥₒ | 0 | Eᵣᵥₒ |

It is assumed that a start location of the fourth bit sequence is a location 0. Because an offset of a start location of the fifth bit sequence relative to the start location of the fourth bit sequence is Eᵣᵥ₀, and the offset is a length of the fourth bit sequence, the start location of the fifth bit sequence is a location Eᵣᵥ₀. When the information source bit sequence is retransmitted, the encoding apparatus may read the bit sequence from the location 0 as the bit sequence 1 read during retransmission; or the encoding apparatus may read the bit sequence from the location Eᵣᵥ₀ as the bit sequence 2 read during retransmission.

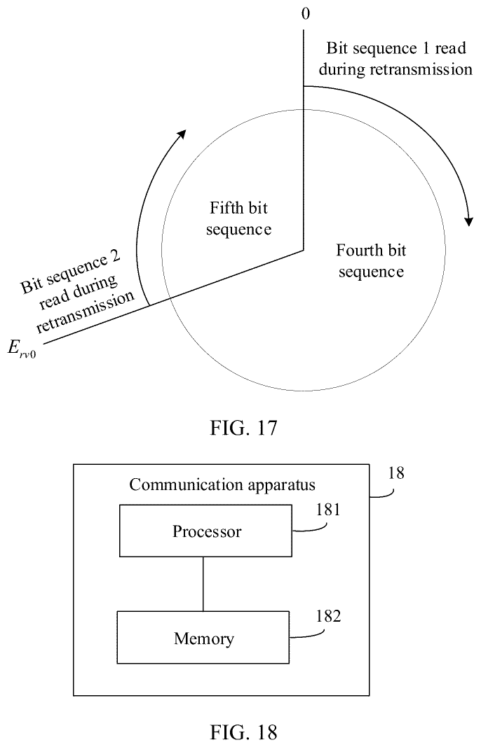

FIG. 17 is a diagram of a relationship between a bit sequence and a start location. The fourth bit sequence and the fifth bit sequence form the entire second buffer. The start location of the fourth bit sequence is 0, and the start location of the fifth bit sequence is Eᵣᵥ₀. A start location of a bit sequence read during retransmission may be the same as that of the fourth bit sequence, for example, a bit sequence 1 read during retransmission in FIG. 17. Alternatively, a start location of a bit sequence read during retransmission may be the same as that of the fifth bit sequence, for example, a bit sequence 2 read during retransmission in FIG. 17.

It should be noted that when the encoding apparatus is integrated into a transmit-end apparatus, actions in the embodiments shown in FIG. 7 to FIG. 17 may also be performed by the transmit-end apparatus.

Because the transmit-end apparatus in the foregoing embodiment may use the architecture of the communication apparatus 600 shown in FIG. 6, actions of the transmit-end apparatus in the foregoing embodiment may be performed by the processor 601 or the processor 607 in the communication apparatus 600 shown in FIG. 6 by invoking the application program code stored in the memory 603, to instruct the transmit-end apparatus to execute the actions. This is not limited in this embodiment.

It may be understood that in the foregoing embodiments, the methods and/or steps implemented by the encoding apparatus may be alternatively implemented by a component (for example, a chip or a circuit) that can be used in the encoding apparatus.

Correspondingly, an embodiment of this application further provides a communication apparatus, and the communication apparatus is configured to implement the foregoing various methods. It may be understood that, to implement the foregoing functions, the communication apparatus includes a hardware structure and/or a software module for performing a corresponding function. A person skilled in the art should be easily aware that, in combination with units and algorithm steps of the examples described in embodiments disclosed in this specification, this application may be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

In embodiments of this application, the communication apparatus may be divided into functional modules based on the foregoing method embodiments. For example, each functional module may be obtained through division based on each corresponding function, or two or more functions may be integrated into one processing module. The integrated module may be implemented in a form of hardware, or may be implemented in a form of a software functional module. It should be noted that, in embodiments of this application, division into the modules is an example, and is merely logical function division. In actual implementation, another division manner may be used.

FIG. 18 is a diagram of a structure of a communication apparatus 18. The communication apparatus 18 includes a processor 181 and a memory 182 coupled to the processor 181.

For example, the communication apparatus 18 is the encoding apparatus in the foregoing method embodiments. The processor 181 is configured to perform bit mapping on kᵣᵥ₁ information source bits whose reliability is lower than a first threshold in a first bit sequence, to obtain a second bit sequence, where the first bit sequence is a bit sequence obtained by performing bit mapping after CRC bits are added to an information source bit sequence, the kᵣᵥ₁ information source bits are bits in the information source bit sequence, and a length of the first bit sequence is equal to a length of the second bit sequence. The processor 181 is further configured to perform an exclusive OR operation on bits in a bit sequence obtained by encoding the first bit sequence and bits in a bit sequence obtained by encoding the second bit sequence, to obtain a third bit sequence. Alternatively, the processor 181 is further configured to: encode the second bit sequence, to obtain a third bit sequence. The processor 181 is further configured to map, to an OFDM symbol, the third bit sequence and the bit sequence obtained by encoding the first bit sequence.

In a possible implementation, that the processor 181 is further configured to map, to an OFDM symbol, the third bit sequence and the bit sequence obtained by encoding the first bit sequence includes that the processor is configured to: perform rate matching on the bit sequence obtained by encoding the first bit sequence, then perform segmentation to obtain M₁ groups of S sections, and perform the following operations on an x₁^{th} group of S sections: repeating the x₁^{th} group of S sections for Nᵣᵥ₀ times, and performing cyclic shift based on a corresponding CSS parameter in each repetition, to obtain Nᵣᵥ₀×S sections, where M₁, S, x₁, and Nᵣᵥ₀ are all positive integers, and 1≤x₁≤M₁; the processor is configured to: perform rate matching on the third bit sequence, then perform segmentation to obtain M₁ groups of S sections, and perform the following operations on an x₂^{th} group of S sections: repeating the x₂^{th} group of S sections for Nᵣᵥ₁ times, and performing cyclic shift based on a corresponding CSS parameter in each repetition, to obtain Nᵣᵥ₁×S sections, where x₂ and Nᵣᵥ₁ are both positive integers, and 1≤x₂≤M₁; and the processor is configured to: sequentially concatenate the Nᵣᵥ₀×S sections and the Nᵣᵥ₁×S sections, and perform mapping to the OFDM symbol; or concatenate the Nᵣᵥ₀×S sections and the Nᵣᵥ₁×S sections in an interleaving manner in a unit of a section, and perform mapping to the OFDM symbol.

In a possible implementation, Kᵣᵥ₁ bits whose reliability is higher than a second threshold in the second bit sequence are obtained by adding Lᵣᵥ₁ CRC bits to kᵣᵥ₁ information source bits whose reliability is lower than the first threshold in the first bit sequence, where Kᵣᵥ₁=kᵣᵥ₁+Lᵣᵥ₁, kᵣᵥ₁, Lᵣᵥ₁, and Kᵣᵥ₁ are positive integers.

In a possible implementation, that the processor 181 is further configured to: perform rate matching on the bit sequence obtained by encoding the first bit sequence, and then perform segmentation to obtain M₁ groups of S sections includes that the processor is configured to: perform division to obtain M codewords, after rate matching is performed on the bit sequence obtained by encoding the first bit sequence, where each codeword includes E bits; repeat a final codeword in the M codewords for a plurality of times, so that a quantity of codewords is H×M₂; and divide the H×M₂ codewords into M₂ groups, where each group includes H codewords; and the processor is configured to perform the following operations on an x₃^{th} group of H codewords: concatenating the H codewords, and placing concatenated H×E bits into the memory 182; and concatenating first B×S−H×E bits in the H codewords at an end of the H codewords, where H, E, M₂, and x₃ are all positive integers, 1≤x₃≤M₂, and B represents a quantity of bits in each section; and reading B×S bits from the memory 182, to generate one group of S sections, where each section includes B bits.

In a possible implementation, that the processor 181 is further configured to: perform rate matching on the third bit sequence, and then perform segmentation to obtain M₁ groups of S sections includes that the processor is configured to: perform division to obtain M codewords, after rate matching is performed on the third bit sequence, where each codeword includes E bits; repeat a final codeword in the M codewords for a plurality of times, so that a quantity of codewords is H×M₂; and divide the H×M₂ codewords into M₂ groups, where each group includes H codewords; and the processor is configured to perform the following operations on an x₃^{th} group of H codewords: concatenating the H codewords, and placing concatenated H×E bits into the memory 182; and concatenating first B×S−H×E bits in the H codewords at an end of the H codewords, where H, E, M₂, and x₃ are all positive integers, 1≤x₃≤M₂, and B represents a quantity of bits in each section; and reading B×S bits from the memory 182, to generate one group of S sections, where each section includes B bits.

In a possible implementation, that the processor 181 is further configured to perform rate matching on the bit sequence obtained by encoding the first bit sequence includes that the processor is configured to perform bit interleaving on a fourth bit sequence, where the fourth bit sequence is a bit sequence obtained by performing sub-block interleaving and bit selection on the bit sequence obtained by encoding the first bit sequence; and that the processor 181 is further configured to perform rate matching on the third bit sequence includes that the processor is configured to perform bit interleaving on a fifth bit sequence, where the fifth bit sequence is a bit sequence obtained by performing sub-block interleaving and bit selection on the third bit sequence.

In a possible implementation, the processor 181 is further configured to place a fourth bit sequence and a fifth bit sequence into the memory 182. The fourth bit sequence is a bit sequence obtained by performing sub-block interleaving and bit selection on the bit sequence obtained by encoding the first bit sequence. The fifth bit sequence is a bit sequence obtained by performing sub-block interleaving and bit selection on the third bit sequence. The processor 181 is further configured to: when the information source bit sequence is retransmitted, read the bit sequence from an initial bit of the fourth bit sequence or the fifth bit sequence, and perform bit interleaving on the read bit sequence.

All related content of the steps in the foregoing method embodiments may be cited in function descriptions of the corresponding functional modules. Details are not described herein again.

In this embodiment, the communication apparatus 18 is presented in a form of functional modules obtained through division in an integrated manner. The “module” herein may be an ASIC, a circuit, a processor that executes one or more software or firmware programs, a memory, an integrated logic circuit, and/or another component capable of providing the foregoing functions.

When the communication apparatus 18 is the encoding apparatus in the foregoing method embodiments, in a simple embodiment, a person skilled in the art may figure out that the communication apparatus 18 may be included in the communication apparatus 600 shown in FIG. 6.

For example, the processor 601 or 607 in the communication apparatus 600 shown in FIG. 6 may invoke the computer-executable instructions stored in the memory 603, so that the communication apparatus 600 performs the encoding method in the foregoing method embodiments. Specifically, functions/implementation processes of the processor 181 in FIG. 18 may be implemented by the processor 601 or 607 in the communication apparatus 600 shown in FIG. 6 by invoking the computer-executable instructions stored in the memory 603. Functions/implementation processes of the memory 182 in FIG. 18 may be implemented by the memory 603 in FIG. 6.

The communication apparatus 18 provided in this embodiment may perform the foregoing encoding method. Therefore, for technical effects that can be achieved by the communication apparatus 18, refer to the foregoing method embodiments. Details are not described herein again.

It should be noted that one or more of the foregoing modules or units may be implemented by using software, hardware, or a combination thereof. When any one of the foregoing modules or units is implemented by software, the software exists in a form of a computer program instruction, and is stored in the memory. The processor may be configured to execute the program instruction and implement the foregoing method procedure. The processor may be built into a SoC (system on a chip) or an ASIC, or may be an independent semiconductor chip. In addition to a core configured to perform calculation or processing by executing a software instruction, the processor may further include a necessary hardware accelerator, for example, a field-programmable gate array (field-programmable gate array, FPGA), a PLD (programmable logic device), or a logic circuit that implements a dedicated logic operation.

When the foregoing modules or units are implemented by using hardware, the hardware may be any one or any combination of a CPU, a microprocessor, a digital signal processing (digital signal processing, DSP) chip, a microcontroller unit (microcontroller unit, MCU), an artificial intelligence processor, an ASIC, a SoC, an FPGA, a PLD, a dedicated digital circuit, a hardware accelerator, or a non-integrated discrete device, and the hardware may run necessary software or does not depend on software to perform the foregoing method procedures.

Optionally, an embodiment of this application further provides a chip system, including: at least one processor and an interface. The at least one processor is coupled to a memory through an interface. When the at least one processor executes a computer program or instructions in the memory, the method in any one of the foregoing method embodiments is performed. In a possible implementation, the communication apparatus further includes the memory. Optionally, the chip system may include a chip, or may include a chip and another discrete component. This is not specifically limited in this embodiment of this application.

All or some of the foregoing embodiments may be implemented by using software, hardware, firmware, or any combination thereof. When a software program is used to implement embodiments, embodiments may be implemented completely or partially in a form of a computer program product. The computer program product includes one or more computer instructions. When the computer program instructions are loaded and executed on the computer, the procedure or functions according to embodiments of this application are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (digital subscriber line, DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid-state disk (solid state disk, SSD)), or the like.

Although this application is described with reference to embodiments, in a process of implementing this application that claims protection, a person skilled in the art may understand and implement another variation of the disclosed embodiments by viewing the accompanying drawings, disclosed content, and appended claims. In the claims, “comprising” (comprising) does not exclude another component or another step, and “a” or “one” does not exclude a case of multiple. A single processor or another unit may implement several functions enumerated in the claims. Some measures are recorded in dependent claims that are different from each other, but this does not mean that these measures cannot be combined to produce better effect.

Although this application is described with reference to specific features and embodiments thereof, it is clear that various modifications and combinations may be made to them without departing from the spirit and scope of this application. Correspondingly, the specification and accompanying drawings are merely example description of this application defined by the accompanying claims, and are considered as any of or all modifications, variations, combinations or equivalents that cover the scope of this application. It is clearly that a person skilled in the art can make various modifications and variations to this application without departing from the spirit and scope of this application. This application is intended to cover these modifications and variations of this application provided that they fall within the scope of protection defined by the following claims and their equivalent technologies.

What is claimed is:

1. An encoding method, wherein the method comprises:
performing bit mapping on kᵣᵥ₁ information source bits whose reliability is lower than a first threshold in a first bit sequence, to obtain a second bit sequence, wherein the first bit sequence is a bit sequence obtained by performing bit mapping after cyclic redundancy check (CRC) bits are added to an information source bit sequence, the kᵣᵥ₁ information source bits are bits in the information source bit sequence, and a length of the first bit sequence is equal to a length of the second bit sequence;
performing one of an exclusive OR operation on bits in a bit sequence obtained by encoding the first bit sequence and bits in a bit sequence obtained by encoding the second bit sequence, to obtain a third bit sequence; or encoding the second bit sequence, to obtain a third bit sequence; and
mapping, to an orthogonal frequency-division multiplexing (OFDM) symbol, the third bit sequence and the bit sequence obtained by encoding the first bit sequence.

2. The method according to claim 1, wherein the mapping, to an OFDM symbol, the third bit sequence and the bit sequence obtained by encoding the first bit sequence comprises:
performing rate matching on the bit sequence obtained by encoding the first bit sequence, then performing segmentation to obtain M₁ groups of S sections, and performing the following operations on an x₁^{th} group of S sections:
repeating the x₁^{th} group of S sections for Nᵣᵥ₀ times, and performing cyclic shift based on a corresponding cyclic section shift (CSS) parameter in each repetition, to obtain Nᵣᵥ₀×S sections, wherein M₁, S, x₁, and Nᵣᵥ₀ are all positive integers, and 1≤x₁≤M₁;
performing rate matching on the third bit sequence, then performing segmentation to obtain M₁ groups of S sections, and performing the following operations on an x₂^{th} group of S sections:
repeating the x₂^{th} group of S sections for Nᵣᵥ₁ times, and performing cyclic shift based on a corresponding CSS parameter in each repetition, to obtain Nᵣᵥ₁×S sections, wherein x₂ and Nᵣᵥ₁ are both positive integers, and 1≤x₂≤M₁; and
performing one of sequentially concatenating the Nᵣᵥ₀×S sections and the Nᵣᵥ₁×S sections, and performing mapping to the OFDM symbol; or
concatenating the Nᵣᵥ₀×S sections and the Nᵣᵥ₁×S sections in an interleaving manner in a unit of a section, and performing mapping to the OFDM symbol.

3. The method according to claim 1, wherein Kᵣᵥ₁ bits whose reliability is higher than a second threshold in the second bit sequence are obtained by adding Lᵣᵥ₁ CRC bits to kᵣᵥ₁ information source bits whose reliability is lower than the first threshold in the first bit sequence, wherein Kᵣᵥ₁=kᵣᵥ₁+Lᵣᵥ₁, kᵣᵥ₁, Lᵣᵥ₁, and Kᵣᵥ₁ are positive integers.

4. The method according to claim 2, wherein the performing rate matching on the bit sequence obtained by encoding the first bit sequence, and then performing segmentation to obtain M₁ groups of S sections comprises:
performing division to obtain M codewords after rate matching is performed on the bit sequence obtained by encoding the first bit sequence, wherein each codeword comprises E bits;
repeating a final codeword in the M codewords for a plurality of times, so that a quantity of codewords is H×M₂;
dividing the H×M₂ codewords into M₂ groups, wherein each group comprises H codewords; and
performing the following operations on an x₃^{th} group of H codewords:
concatenating the H codewords, and placing concatenated H×E bits into a first cyclic buffer; and concatenating first B×S−H×E bits in the H codewords at an end of the H codewords, wherein H, E, M₂, and x₃ are all positive integers, 1≤x₃≤M₂, and B represents a quantity of bits in each section; and
reading B×S bits from the cyclic buffer, to generate one group of S sections, wherein each section comprises B bits.

5. The method according to claim 2, wherein the performing rate matching on the third bit sequence, and then performing segmentation to obtain M₁ groups of S sections comprises:
performing division to obtain M codewords after rate matching is performed on the third bit sequence, wherein each codeword comprises E bits;
repeating a final codeword in the M codewords for a plurality of times, so that a quantity of codewords is H×M₂;
dividing the H×M₂ codewords into M₂ groups, wherein each group comprises H codewords; and
performing the following operations on an x₃^{th} group of H codewords:
concatenating the H codewords, and placing concatenated H×E bits into a first cyclic buffer; and concatenating first B×S−H×E bits in the H codewords at an end of the H codewords, wherein H, E, M₂, and x₃ are all positive integers, 1≤x₃≤M₂, and B represents a quantity of bits in each section; and
reading B×S bits from the cyclic buffer, to generate one group of S sections, wherein each section comprises B bits.

6. The method according to claim 2, wherein the performing rate matching on the bit sequence obtained by encoding the first bit sequence comprises:
performing bit interleaving on a fourth bit sequence, wherein the fourth bit sequence is a bit sequence obtained by performing sub-block interleaving and bit selection on the bit sequence obtained by encoding the first bit sequence; and
the performing rate matching on the third bit sequence comprises:
performing bit interleaving on a fifth bit sequence, wherein the fifth bit sequence is a bit sequence obtained by performing sub-block interleaving and bit selection on the third bit sequence.

7. The method according to claim 1, wherein the method further comprises:
placing a fourth bit sequence and a fifth bit sequence into a second cyclic buffer, wherein the fourth bit sequence is a bit sequence obtained by performing sub-block interleaving and bit selection on the bit sequence obtained by encoding the first bit sequence, and the fifth bit sequence is a bit sequence obtained by performing sub-block interleaving and bit selection on the third bit sequence; and
when the information source bit sequence is retransmitted, reading the bit sequence from an initial bit of the fourth bit sequence or the fifth bit sequence, and performing bit interleaving on the read bit sequence.

8. An encoding apparatus, wherein the encoding apparatus comprises:
a processor; and
a memory coupled to the processor, wherein the memory is configured to store a program and data and the processor is configured to execute the program stored in the memory, to implement the following functions:
perform bit mapping on kᵣᵥ₁ information source bits whose reliability is lower than a first threshold in a first bit sequence, to obtain a second bit sequence, wherein the first bit sequence is a bit sequence obtained by performing bit mapping after cyclic redundancy check (CRC) bits are added to an information source bit sequence, the kᵣᵥ₁ information source bits are bits in the information source bit sequence, and a length of the first bit sequence is equal to a length of the second bit sequence;
perform an exclusive OR operation on bits in a bit sequence obtained by encoding the first bit sequence and bits in a bit sequence obtained by encoding the second bit sequence, to obtain a third bit sequence; or the processor is further configured to encode the second bit sequence, to obtain a third bit sequence; and
map, to an orthogonal frequency-division multiplexing (OFDM) symbol, the third bit sequence and the bit sequence obtained by encoding the first bit sequence.

9. The encoding apparatus according to claim 8, wherein map, to an OFDM symbol, the third bit sequence and the bit sequence obtained by encoding the first bit sequence comprises:
perform rate matching on the bit sequence obtained by encoding the first bit sequence, then perform segmentation to obtain M₁ groups of S sections, and perform the following operations on an x₁^{th} group of S sections: repeating the x₁^{th} group of S sections for Nᵣᵥ₀ times, and performing cyclic shift based on a corresponding cyclic section shift (CSS) parameter in each repetition, to obtain Nᵣᵥ₀×S sections, wherein M₁, S, x₁, and Nᵣᵥ₀ are all positive integers, and 1≤x₁≤M₁;
perform rate matching on the third bit sequence, then perform segmentation to obtain M₁ groups of S sections, and perform the following operations on an x₂^{th} group of S sections: repeating the x₂^{th} group of S sections for Nᵣᵥ₁ times, and performing cyclic shift based on a corresponding CSS parameter in each repetition, to obtain Nᵣᵥ₁×S sections, wherein x₂ and Nᵣᵥ₁ are both positive integers, and 1≤x₂≤M₁; and
sequentially concatenate the Nᵣᵥ₀×S sections and the Nᵣᵥ₁×S sections, and perform mapping to the OFDM symbol; or concatenate the Nᵣᵥ₀×S sections and the Nᵣᵥ₁×S sections in an interleaving manner in a unit of a section, and perform mapping to the OFDM symbol.

10. The encoding apparatus according to claim 8, wherein Kᵣᵥ₁ bits whose reliability is higher than a second threshold in the second bit sequence are obtained by adding Lᵣᵥ₁ CRC bits to kᵣᵥ₁ information source bits whose reliability is lower than the first threshold in the first bit sequence, wherein Kᵣᵥ₁=kᵣᵥ₁+Lᵣᵥ₁, kᵣᵥ₁, Lᵣᵥ₁, Lᵣᵥ₁, and Kᵣᵥ₁ are positive integers.

11. The encoding apparatus according to claim 9, wherein perform rate matching on the bit sequence obtained by encoding the first bit sequence, and then perform segmentation to obtain M₁ groups of S sections comprises:
perform division to obtain M codewords, after rate matching is performed on the bit sequence obtained by encoding the first bit sequence, wherein each codeword comprises E bits; repeat a final codeword in the M codewords for a plurality of times, so that a quantity of codewords is H×M₂; and divide the H×M₂ codewords into M₂ groups, wherein each group comprises H codewords; and
perform the following operations on an x₃^{th} group of H codewords: concatenating the H codewords, and placing concatenated H×E bits into the memory; and concatenating first B×S−H×E bits in the H codewords at an end of the H codewords, wherein H, E, M₂, and x₃ are all positive integers, 1≤x₃≤M₂, and B represents a quantity of bits in each section; and reading B×S bits from the memory, to generate one group of S sections, wherein each section comprises B bits.

12. The encoding apparatus according to claim 9, wherein perform rate matching on the third bit sequence, and then perform segmentation to obtain M₁ groups of S sections comprises:
perform division to obtain M codewords, after rate matching is performed on the third bit sequence, wherein each codeword comprises E bits; repeat a final codeword in the M codewords for a plurality of times, so that a quantity of codewords is H×M₂; and divide the H×M₂ codewords into M₂ groups, wherein each group comprises H codewords;
perform the following operations on an x₃^{th} group of H codewords: concatenating the H codewords, and placing concatenated H×E bits into the memory; and concatenating first B×S−H×E bits in the H codewords at an end of the H codewords, wherein H, E, M₂, and x₃ are all positive integers, 1≤x₃≤M₂, and B represents a quantity of bits in each section; and
read B×S bits from the memory, to generate one group of S sections, wherein each section comprises B bits.

13. The encoding apparatus according to claim 9, wherein perform rate matching on the bit sequence obtained by encoding the first bit sequence comprises:
perform bit interleaving on a fourth bit sequence, wherein the fourth bit sequence is a bit sequence obtained by performing sub-block interleaving and bit selection on the bit sequence obtained by encoding the first bit sequence; and
perform rate matching on the third bit sequence comprises:
perform bit interleaving on a fifth bit sequence, wherein the fifth bit sequence is a bit sequence obtained by performing sub-block interleaving and bit selection on the third bit sequence.

14. The encoding apparatus according to claim 8, wherein the functions further comprise:
place a fourth bit sequence and a fifth bit sequence into the memory, wherein the fourth bit sequence is a bit sequence obtained by performing sub-block interleaving and bit selection on the bit sequence obtained by encoding the first bit sequence, and the fifth bit sequence is a bit sequence obtained by performing sub-block interleaving and bit selection on the third bit sequence; and
when the information source bit sequence is retransmitted, read the bit sequence from an initial bit of the fourth bit sequence or the fifth bit sequence, and perform bit interleaving on the read bit sequence.

15. A computer-readable storage medium, wherein the computer-readable storage medium stores a computer program, and when the computer program is executed by a computer, the computer is enabled to perform the method comprising:
performing bit mapping on kᵣᵥ₁ information source bits whose reliability is lower than a first threshold in a first bit sequence, to obtain a second bit sequence, wherein the first bit sequence is a bit sequence obtained by performing bit mapping after cyclic redundancy check (CRC) bits are added to an information source bit sequence, the kᵣᵥ₁ information source bits are bits in the information source bit sequence, and a length of the first bit sequence is equal to a length of the second bit sequence;
performing one of an exclusive OR operation on bits in a bit sequence obtained by encoding the first bit sequence and bits in a bit sequence obtained by encoding the second bit sequence, to obtain a third bit sequence; or encoding the second bit sequence, to obtain a third bit sequence; and
mapping, to an orthogonal frequency-division multiplexing (OFDM) symbol, the third bit sequence and the bit sequence obtained by encoding the first bit sequence.
